(19) United States
(12) Patent Application Publication
(10) Pub. No.: US 2026/0157896 A1
(43) Pub. Date: Jun. 11, 2026

(54) VEHICLE ACCESS SYSTEM WITH ENHANCED INSTALLATION AND USABILITY FEATURES AND SECUREMENT SOLUTIONS

(71) Applicant: The Braun Corporation, Winamac, IN (US)

(72) Inventors: Scott Stranko, Noblesville, IN (US); Luken Rigsbee, Indianapolis, IN (US)

(73) Assignee: The Braun Corporation, Winamac, IN (US)

(21) Appl. No.: 19/350,816

(22) Filed: Oct. 6, 2025

Related U.S. Application Data
(60) Provisional application No. 63/788,637, filed on Apr. 14, 2025.
(60) Provisional application No. 63/706,628, filed on Oct. 12, 2024.

(51) Int. Cl. A61G 3/06; B60P 1/43

(52) U.S. Cl. CPC A61G 3/061; B60P 1/431

(57) ABSTRACT

An access device for vehicles facilitates entry and exit for physically limited. The device may include a platform assembly guided by two mechanisms with differing degrees of freedom, allowing precise movement while accommodating installation tolerances. The device may include a torsion spring lift assist that counterbalances the platform's weight, reducing user effort in transitioning between horizontal and angled positions. The device may also include a transition flap lift assist with a biasing mechanism to ease movement and ensure secure positioning. The device may also include a handle that is unidirectionally coupled to a latch mechanism for smooth one-handed stowage and deployment of the platform. Additionally, an integrated mobility device securement system may span the access device, utilizing rear retractors positioned above the floor weldment's bottom wall and beneath a false floor surface and front retractors embedded in the weldment’s front wall.

### CROSS REFERENCE TO OTHER APPLICATIONS

This application claims priority to U.S. Provisional Patent Application No. 63/788,637, filed on April 14, 2025, and U.S. Provisional Patent Application No. 63/706,628, filed 12 October 2024, the contents of which are incorporated by reference. This application further incorporates the disclosures of U.S. Patent Application No. 18/522,997, filed 29 November 2023, PCT Patent Application No. PCT/US22/39960, filed 10 August 2022, and U.S. Patent No. 9,969,437, issued 15 May 2018, by reference.

### FIELD OF THE DISCLOSURE

This disclosure relates to vehicle accessibility systems, specifically to systems designed to facilitate access for physically limited passengers. It encompasses innovative mechanisms for guiding and supporting access platforms, such as guide mechanisms with varying degrees of freedom and torsion spring lift assists, as well as features for enhancing the usability of transition flaps and ramp latching mechanisms. Additionally, the disclosure addresses securement systems integrated into vehicle flooring, providing solutions for securing mobility devices within vehicles. The focus is on improving ease of installation, operation, and safety for users.

In some embodiments, the disclosure pertains to innovative guide mechanisms used in a ramp assembly that facilitate field assembly. Specifically, it addresses the use of two distinct guide mechanisms with differing degrees of freedom, allowing for easier installation and alignment in the vehicle. This innovation enables a thinner ramp profile, reduces vehicle step-in height, decreases the deployed ramp angle, and enhances interior ceiling height, thereby improving overall accessibility and passenger comfort.

The present disclosure further pertains to enhancements in ramp systems for vehicles, specifically through the integration of torsion springs to assist in the stowage of the ramp. These torsion springs are designed to offset the weight of the ramp, providing consistent assistance throughout its movement. By being preloaded, the torsion springs offer support not only when the ramp is in a deployed position but also when it is stowed horizontally. This innovation facilitates easier ramp operation and contributes to a more user-friendly experience. Additionally, the strategic placement of the torsion springs on the carriage, rather than beneath the ramp, allows for a shallower ramp cavity. This design improvement results in a thinner floor profile and a reduced step-in height, thereby enhancing vehicle accessibility and usability for physically limited passengers.

The present disclosure also encompasses advancements in the operation of ramp systems through the introduction of a transition flap lift assist mechanism. This feature is designed to alleviate the physical effort required to transition the ramp platform from a deployed position to a stowed position. By incorporating a biasing assembly that engages with the transition flap, the mechanism provides an upward force that counteracts the weight of the transition flap and any additional biasing forces. This effectively reduces the strain on users by offsetting the downward force exerted on the ramp platform, facilitating smoother and more manageable transitions. The disengagement of the biasing mechanism as the ramp platform moves towards the stowed position ensures that the transition flap settles securely, enhancing both safety and ease of use. This innovation is particularly beneficial for users with limited strength, offering a more accessible and comfortable vehicle experience.

### BACKGROUND

Vehicle manufacturers do not currently mass-produce passenger motor vehicles specifically designed to transport passengers having physical limitations, either as a driver or as a non-driving passenger. Consequently, mass-produced passenger vehicles (hereinafter “original equipment manufacturer (OEM) vehicles”), such as a vans, buses, sport-utility vehicles, and motor coaches, are modified, or retrofitted, by a number of aftermarket companies dedicated to supplying vehicles to physically limited passengers. OEM vehicles can be modified by removing certain parts or structures within the vehicle and replacing those parts with parts specifically designed to accommodate the physically limited passenger. For example, in one configuration, a floor of an OEM vehicle is removed and replaced with a new lowered floor, or otherwise modified to accommodate an entry and exit of the physically limited individual through a side door or entrance of the vehicle.

In some embodiments, the vehicle is retrofitted with a vehicle access device, such as a ramp, which enables a physically limited individual using a wheelchair, herein referred to as a wheelchaired passenger, to enter and exit the vehicle without the assistance of another individual. The ramp may be located adjacent a side entry door, in which case the vehicle is commonly referred to as a side-entry wheelchair accessible vehicle (“WAV”), or a rear entry door, in which case the vehicle is commonly referred to as a rear-entry WAV. Once inside a side-entry WAV, an individual who uses the assisted entrance is located in a rear passenger compartment of the vehicle adjacent to or behind the side entrance. Regulations govern a maximum wheelchair ramp angle, resulting in vehicle modifiers by lowering the vehicle floor to satisfy this regulation.

Designing a wheelchair-accessible vehicle involves carefully balancing the need to lower the vehicle floor to achieve a compliant ramp angle with the necessity of maintaining sufficient ground clearance. Lowering the floor is essential to provide a shallower ramp angle, which facilitates easier access for wheelchair users and complies with regulatory requirements. However, reducing the floor height can adversely impact the vehicle's ground clearance, potentially leading to challenges such as increased risk of undercarriage damage when navigating uneven terrain or speed bumps. Therefore, manufacturers must consider innovative solutions that allow for both a lowered floor and adequate ground clearance. This balance ensures that the vehicle remains practical and functional for everyday use while still being accessible to physically limited passengers. In this context, the design of the ramp system, including its profile and deployment mechanism, plays a critical role in optimizing these competing priorities without compromising the safety and comfort of the vehicle's occupants.

Traditional in-floor ramp systems commonly employed in retrofitted vehicles typically utilize two guide members or rails positioned on either side of the ramp platform and carriage. These guide rails are integral to the functionality of the ramp, serving to direct the platform as it transitions smoothly between its stowed position beneath the vehicle floor and its deployed position outside the vehicle. In known conventional designs, the guide rails are identical and precisely aligned in a fixed housing to ensure stable and resistance-free movement of the ramp. However, the use of such a housing can significantly increase the height of the ramp package, thereby limiting the ability to achieve a lower vehicle floor height and compromising the overall accessibility and design efficiency of the vehicle.

The process of integrating ramp systems into vehicles can be approached through two primary methods, which are referred to herein as a factory assembly and a field assembly. Factory assembly involves pre-assembling the ramp components into a single unit within a controlled manufacturing environment before installation into the vehicle. This method allows for precise control over tolerances and alignment, ensuring that the ramp components interact smoothly and efficiently. Identical guide mechanisms are typically used in factory-assembled ramps, facilitating precise alignment and reducing the risk of binding or resistance during operation. Field assembly, on the other hand, involves installing individual ramp components or ramp sub-systems directly into the vehicle. While this approach offers flexibility and the advantage of achieving a thinner ramp profile, it presents challenges in maintaining precise alignment of components within permissible tolerances. Misalignments can lead to operational issues such as binding or increased resistance as the ramp moves between stowed and deployed positions.

Securing the wheelchaired passenger during the operation of the vehicle is crucial for their safety and stability. Properly securing the wheelchaired passenger ensures that the passenger remains in place, preventing any movement that could lead to injury during sudden stops or turns. To accomplish this, the wheelchaired passenger must maneuver the rear passenger compartment of the vehicle to a securement zone where a securement system is configured to safely secure the wheelchaired passenger. It is challenging to provide adequate space in a lowered floor assembly for both a ramp and a securement system. Many solutions are to solely include one securement area. This limits the ability to transport more than one wheelchaired passenger at a time, which is often undesirable.

### SUMMARY OF THE EMBODIMENTS

One embodiment described herein introduces a novel solution to the problems of the prior art by employing two different ramp carriage guide mechanisms with varying degrees of freedom. This configuration allows for greater tolerance stack-up during installation and accommodates misalignments, ensuring smooth operation of the ramp carriage. The adoption of this approach enables a thinner ramp profile, contributing to a lower floor height, reduced vehicle step-in height, decreased deployed ramp angle, and increased interior ceiling height. These improvements are particularly beneficial in enhancing accessibility and comfort for wheelchaired passengers, making field-assembled ramps a more viable and advantageous option.

In addition to the novel guide mechanism approach, advancements in ramp system design have been made through the integration of torsion springs within the carriage assembly. These torsion springs are strategically employed to counterbalance the weight of the ramp, providing consistent assistance throughout its movement, including, in some embodiments, when the ramp is in a horizontal position. This is a significant improvement over traditional designs that rely on leaf springs, which counterbalance weight when the ramp is at an angle relative to horizontal. The preloading capability of the torsion springs ensures a smoother and more efficient ramp operation, reducing the physical effort required by users to stow the ramp. Furthermore, by positioning the torsion springs on the carriage rather than beneath the ramp, the design allows for a shallower ramp cavity. This results in a thinner floor profile and a lowered step-in height, enhancing the vehicle's accessibility without compromising ground clearance. These innovations collectively address the limitations of prior designs, providing a more compact, user-friendly, and accessible solution for wheelchair-accessible vehicles.

Another advancement in ramp system technology involves the introduction of a transition flap lift assist mechanism, designed to alleviate the physical effort required during the transition of the ramp platform from a deployed to a stowed position. Traditional ramp systems can pose significant challenges for users, particularly due to the added weight of the transition flap resting on the ramp platform and any additional biasing forces. The transition flap lift assist incorporates a biasing assembly that engages with the transition flap to provide an upward force, counteracting these additional weights and forces. This innovative mechanism effectively reduces the strain on users by offsetting the downward force exerted on the ramp platform, facilitating a smoother and more manageable transition. The ability of the biasing assembly to disengage as the ramp platform moves towards the stowed position ensures that the transition flap settles securely, enhancing overall safety and ease of use. This development is particularly advantageous for users with limited strength, offering a more accessible and comfortable vehicle experience.

The disclosure further advances ramp system technology with the introduction of transition flap guides. These guides utilize detent members strategically placed on both the base and platform, engaging corresponding detent members on the transition flap. This configuration ensures that the transition flap maintains a secure and stable position when the ramp is in both the stowed and deployed positions. The integration of rollers as corresponding detent members allows for smooth engagement with the platform's top surface, facilitating the transition flap's movement between raised and lowered positions. This design minimizes friction and wear, enhancing the durability and reliability of the access device. By ensuring that the transition flap is securely positioned during operation, this innovation significantly contributes to the overall safety and usability of the ramp system.

The disclosure also encompasses a ramp latching mechanism comprising a handle configured to manipulate a latch between a locked and unlocked position. The mechanism incorporates a unidirectional coupling between the handle and a latch, allowing for intuitive operation. As the user moves the handle, the platform is efficiently transitioned between the stowed and deployed positions, with the latch mechanism unlocking in response to a handle pull and automatically locking to secure the platform in the stowed position as the user pushes the handle. This automatic locking feature prevents unintended deployment during vehicle transit, enhancing safety. The ramp handle is designed to rotate about a pivot member, providing ergonomic advantages that reduce user effort. The inclusion of a cam interface between latch members further simplifies ramp operation by pushing the ramp out of the stowed position, ensuring reliable engagement and disengagement.

Also disclosed is an integrated wheelchair securement system. This system incorporates an in-floor access device into a lowered floor assembly. The securement system includes both front and rear retractor tiedowns that span the in-floor access device. To ensure a clear floor surface without obstructions, the rear retractor tiedowns are integrated into the floor above the bottom wall of the floor weldment and beneath a false floor surface, while the front retractor tiedowns are embedded in a front wall of a floor weldment.

### BRIEF DESCRIPTION OF DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a perspective view illustrating a vehicle that has been modified to include a ramp assembly, showcasing the platform in a deployed position, permitting access by physically limited passengers.

FIG. 2 is a perspective view detailing a lowered floor weldment for the modified vehicle.

FIG. 3 is a perspective view of the lowered floor assembly assembled into the lowered floor weldment, illustrating the arrangement of the ramp assembly and securement areas in the vehicle.

FIG. 4 is a perspective view of the ramp assembly in a stowed position, highlighting the guide mechanisms and carriage assembly.

FIG. 5 is a perspective view of the ramp assembly in a deployed position, illustrating the movement along the guide mechanisms.

FIG. 6 is a front view of the ramp assembly, showing the interaction between the carriage assembly and guide mechanisms.

FIG. 7 is a front view of an alternative configuration for the second guide assembly, demonstrating the flexibility in design.

FIG. 8 is a close-up perspective view of the torsion spring assembly with the ramp in a deployed configuration, highlighting its components.

FIG. 9 is a side view of the torsion spring assembly in a deployed configuration, showing the interaction with the ramp platform.

FIG. 10 is a side view of the torsion spring assembly in a horizontal configuration, illustrating the preloading and potential energy storage.

FIG. 11 is a side view illustrating the transition flap assembly in a lowered position with the ramp platform stowed, reducing step-in height.

FIG. 12 is a side view showing the transition flap in a raised position, allowing for movement of the ramp platform between stowed and deployed positions.

FIG. 13 is a side view with the transition flap in a lowered position, extending the ramp platform to reduce the ramp angle.

FIG. 14 is a perspective view of the handle assembly with the latch mechanism engaged, securing the ramp platform in the stowed position.

FIG. 15 is a detailed perspective view of the handle and latch mechanism, illustrating the engagement and locking features.

FIG. 16 is a perspective view of an alternative handle assembly configuration, showing the lever and latching device.

FIG. 17 is a perspective view of an alternative latching mechanism, highlighting the kick-out bracket and lever operation.

FIG. 18 is a front perspective view of the alternative latching mechanism, illustrating the engaged position.

FIG. 19 is a rear perspective view of the alternative latching mechanism, detailing the kick-out bracket in the unlatched configuration.

FIG. 20 is a perspective view of another embodiment of the handle assembly, featuring a release mechanism for one-handed operation.

FIG. 21 is an exploded view of the floor assembly, showing the modular subfloor and composite floor structure with apertures for securement integration.

FIG. 22 is a perspective view of a first variant of the lowered floor assembly, highlighting the arrangement of securement systems and floor structure.

FIG. 23 is an exploded view of the first variant, showing the modular subfloor and composite floor structure with apertures for securement integration.

FIG. 24 is a perspective view of a second variant of the lowered floor assembly, illustrating the use of retractors within the floor structure.

FIG. 25 is an exploded view of the second variant, showing the modular subfloor and composite floor structure with apertures for securement integration.

Corresponding reference numerals are used to indicate corresponding parts throughout the several views.

It should be understood that the drawings are not necessarily to scale and that the embodiments are sometimes illustrated by graphic symbols, phantom lines, diagrammatic representations and fragmentary views. In certain instances, details which are not necessary for an understanding of the embodiments described and claimed herein or which render other details difficult to perceive may have been omitted. It should be understood, of course, that the inventions described herein are not necessarily limited to the particular embodiments illustrated. Indeed, it is expected that persons of ordinary skill in the art may devise a number of alternative configurations that are similar and equivalent to the embodiments shown and described herein without departing from the spirit and scope of the claims.

### DETAILED DESCRIPTION OF THE EMBODIMENTS

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure. Any alterations and further modifications in the described embodiments and any further applications of the principles of the inventions as described herein are contemplated as would normally occur to one skilled in the art. Although a limited number of embodiments are shown and described, it will be apparent to those skilled in the art that some features that are not relevant to the claimed inventions may not be shown for the sake of clarity.

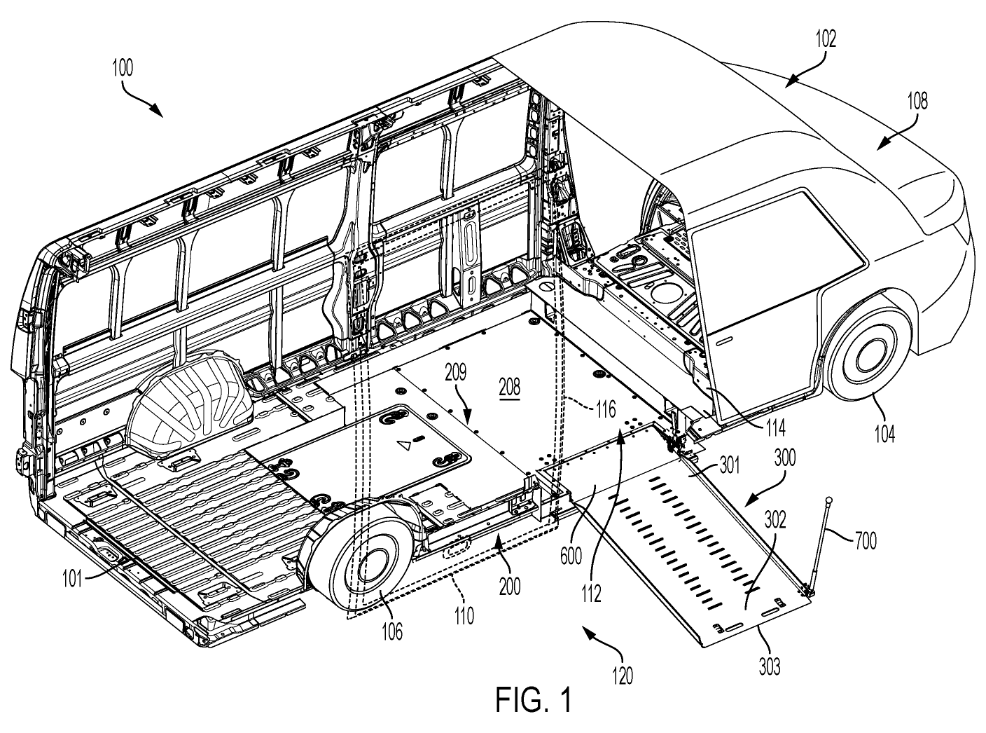

The various embodiments of the inventions described herein were primarily developed with vehicle 100 illustrated in FIG. 1 in mind, commonly identified as a full-size passenger van, available from any number of United States and foreign manufacturers, such as a Ram ProMaster or a Ford Transit. However, it should be recognized that the principles and teachings of the present disclosure, individually or in any combination, may be used for any type of vehicle, whether that be a full size van, minivan, a sport utility vehicle, a truck, an ambulance, a passenger car, a bus, a motorcoach, or any other type of vehicle. As illustrated in FIG. 1, the vehicle 100 includes a unibody construction, but other vehicles having a frame on body construction are also contemplated by the present disclosure. Consequently, the use of the term “vehicle” herein includes all types and kinds of vehicles with a body on frame construction, a unibody construction, or other constructions.

As manufactured by the OEM, the vehicle 100 may include a body or chassis 102 operatively coupled to front wheels 104 and rear wheels 106. The typical interior layout of the vehicle 100 includes a passenger compartment in the front, which houses the driver's seat and a front passenger seat. This compartment provides the primary seating area for operating the vehicle and accommodating a front passenger. Directly behind the front passenger compartment is the cargo compartment, which extends from the back of the front seats to the rear doors of the vehicle 100. This space is generally designed for transporting goods or additional passengers, depending on the vehicle's configuration and intended use. The floor 101 of the vehicle is generally at a single level throughout the interior compartments from front to back, providing a continuous and flat surface that facilitates movement within the vehicle and supports various cargo or seating arrangements. A first passenger side door 108 may be located on the curb side of the vehicle 100 between the front wheels 104 and the rear wheels 106 and provide access to a passenger for sitting in a front seat of the vehicle 100 adjacent to a driver. The vehicle 100 may include a second passenger side door 110 coupled to the frame 102. The side door 110 may slide along one or more tracks or may be a swinging hinged door similar to the first passenger side door 108. In other vehicle types, the side door 110 may be two swinging or two sliding doors configured to provide an opening between the two doors, similar to a bus door. In a vehicle having a single sliding door as is typical on a full size van, the opening 112 may defined on the sides thereof by an edge the B-pillar 114 and the edge 116 of the rear passenger side door 110. In a vehicle having other door configurations, the opening 112 may be defined between the B-pillar 114 and the C-pillar, or between the edges of adjacent double doors.

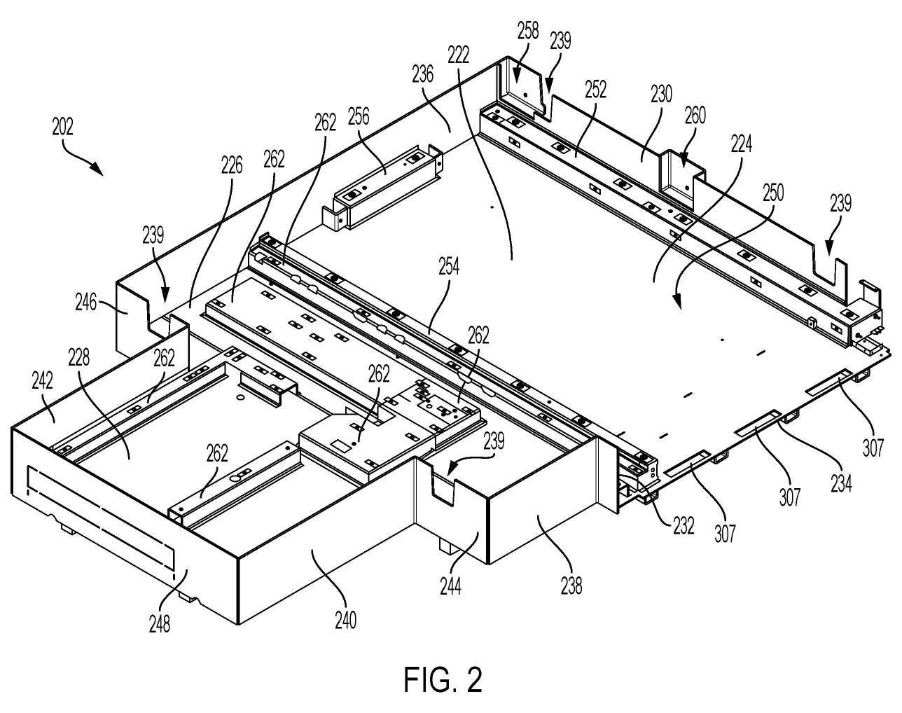

The vehicle 100 depicted in FIG. 1 may be modified from its OEM condition to include a lowered floor weldment 202 depicted in FIG. 2. This modification involves a series of steps that ensure the vehicle maintains structural integrity while accommodating the new floor weldment. The process begins with the removal of a section of the original equipment manufacturer's (OEM) floor 101. This is typically achieved by cutting out the designated portion of the floor 101 using drills, saws, chisels, and other tools. Once the OEM floor section is removed, the space is prepared for the installation of the new floor weldment 202. The new floor weldment 202 is then positioned into the prepared space. This weldment 202 may take form as a pre-fabricated unit designed to fit seamlessly within the vehicle's structure, providing a lowered floor that enhances accessibility. The new floor weldment 202 is welded into place, using welding techniques that ensure strong and secure joints between the weldment 202 and the existing vehicle body 102. This process not only integrates the new floor weldment 202 into the vehicle 100 but also restores any structural strength that may have been compromised during the removal of the original floor section. The result is a modified vehicle with a lowered floor that facilitates easier access for wheelchaired passengers while maintaining the vehicle's performance and safety standards.

In this case, a generally T-shaped portion of the OEM floor 101 has been removed, with the top of the “T” positioned immediately rearward of the front passenger compartment, adjacent to the second-row door opening 112, and extending laterally from the left side to the right side of the vehicle. The base of the removed T-shaped floor 101 portion extends rearward in the vehicle toward the rear doors. A generally U-shaped portion of the OEM floor 101 remains at the rear the vehicle 100, where it is contemplated that multiple rows of ambulatory seating can be mounted, including to the left and right of the base of the removed T-shaped portion. The new floor weldment 202 is correspondingly shaped generally like a “T” and may take form as described in U.S. Patent No. 9,969,437, which is incorporated herein by reference.

With reference to FIG. 2, the floor weldment 202 may comprise a bottom wall 222 that sits at a substantially lower elevation than the OEM floor 101 and is configured to support a ramp, wheelchair securements, a false floor assembly, and other features of the embodiments described hereinafter. The bottom wall 222 may be defined as including three sections, a front bottom wall section 224, a middle bottom wall section 226, and a back bottom wall section 228. The bottom wall 222 may be comprised of a single metal plate, or multiple plates fastened together. Each of the front bottom wall section 224, the middle bottom wall section 226 and the back bottom wall section 228 may be substantially rectangular, and the front bottom wall section 224 may be connected to the middle bottom wall section 226 which may be connected to the back bottom wall section 228. The front bottom wall section 224 may be connected to an upward extending front wall 230 and may be connected to an upward extending first rear wall 232. The front bottom wall section 224 may include an opening edge 234 between the front wall 230 and the upward extending first rear wall 232 on a curb side of the vehicle 100 which may define or align with a door or vehicle access opening of the vehicle 100. The front bottom wall section 224 may also include an upward extending common first side wall 236 on a street side of the vehicle 100, opposite the opening edge 234, which may connect with the front bottom wall section 224, the middle bottom wall section 226 and the front wall 230. The middle bottom wall section 226 may include an upward extending second sidewall 238 on the curb side of the vehicle 100 which may be connected to the bottom wall 222 and may include the upward extending common first sidewall 236 on the street side of the vehicle 100 which may be connected to the bottom wall 222. The bottom wall back section 228 may include an upward extending third sidewall 240 positioned inwardly of the curb side of the vehicle 100 and an upward extending fourth sidewall 242 positioned inwardly of the street side of the vehicle. The third sidewall 240 may be connected to the bottom wall 222 and the fourth sidewall 242 may be connected to the bottom wall 222. The second sidewall 238 may be connected to an upward extending connecting second rear wall 244 which may be connected to the bottom wall 222 and which may be connected to the third sidewall 240. The common first sidewall 236 may be connected to an upward extending third rear wall 246 which may be connected to the bottom wall 222 and which may be connected to the fourth sidewall 242. The back bottom wall section 228 may include the third sidewall 240, the fourth sidewall 242 and a back wall 248, which may be connected to the bottom wall 222, the third sidewall 240 and the fourth sidewall 242.

The front wall 230 may include a pair of opposing notches 239 configured to align the weldment 202 with frame members of the vehicle body 102. The upward extending second rear wall 244 and the upward extending third rear wall 246 may also include similar opposing notches 239 serving the same purpose.

Once connected to the vehicle, the lowered floor weldment 202 defines a base for supporting other components of the modified floor assembly 200. In some embodiments, the weldment 202 may include strategically positioned risers that support and help integrate various components of the system, as described in more detail in the following paragraphs. These risers elevate and stabilize key components of the ramp assembly 300 and wheelchair securement areas 400 and 500. The risers also allow for precise positioning and secure attachment of components, thereby simplifying the installation process. By providing a robust and leveled foundation, the risers also ensure the correct alignment and functionality of these elements within the vehicle. Additionally, the risers support the installation of ramp cover 208 and other floor members described hereinafter, which serve to create a continuous and substantially even false floor surface 209 throughout the boundaries of the modified floor assembly 200. This arrangement not only enhances the structural integrity of the modified floor assembly 200 but also contributes to a seamless integration of the ramp system and securement areas, ensuring ease of access and safety for wheelchair users.

In some embodiments, the weldment 202 defines a pocket 250 for receiving and supporting various components of the ramp assembly 200. The pocket 250 may be substantially defined by a portion of the bottom wall 222 between a first riser 252 at a front of the pocket 250 and a second riser 254 at a rear of the pocket 250, and between the opening edge 234 on the curbside of the vehicle and a third riser 256 and first sidewall 236 at the street side of the vehicle. The first riser 252 may be mounted to and extend upward from the bottom wall 222 adjacent and generally parallel to front wall 230. Although the first riser 252 is shown as a continuous structure extending substantially the entire distance between the first sidewall 236 and the opening edge 234, it is contemplated that the first riser 252 may comprise a series of discontinuous structures that does not span substantially the entire distance between the respective sides of the weldment 202. The second riser 254 may be mounted to and extend upward from the bottom wall 222 adjacent and generally parallel to the first rear wall 232. Although the second riser 254 is shown as a continuous structure extending substantially the entire distance between the first sidewall 236 and the opening edge 234, it is contemplated that the second riser 254 may comprise a series of discontinuous structures that does not span substantially the entire distance between the respective sides of the weldment 202. The third riser 256 may be mounted to and extend upward from the bottom wall 222 adjacent and generally parallel to the first sidewall 236. Although the third riser 256 is shown at a central location between the first and second risers 252, 254 and as a continuous structure, it is contemplated that the third riser 256 may comprise a series of discontinuous structures, may be located off center, and may span substantially the entire distance between the first and second risers 252, 254.

In some embodiments, the top surfaces of the first, second, and third risers 252, 254, 256 are positioned at an elevation suitable for supporting the ramp cover 208, the top surface of which defines a false floor surface 209. To facilitate the attachment of the ramp cover 208, the top surfaces of the risers 252, 254, 256 may be equipped with a plurality of fasteners, such as threaded apertures. These threaded apertures are designed to receive corresponding fasteners, such as bolts, allowing for a secure and reliable fastening of the ramp cover. This configuration not only ensures that the ramp cover is firmly held in place but also allows for easy removal and reinstallation if maintenance or adjustments are needed. The use of threaded fasteners provides a robust connection, preventing any unwanted movement or detachment of the ramp cover during vehicle operation, thus enhancing the safety and durability of the floor assembly.

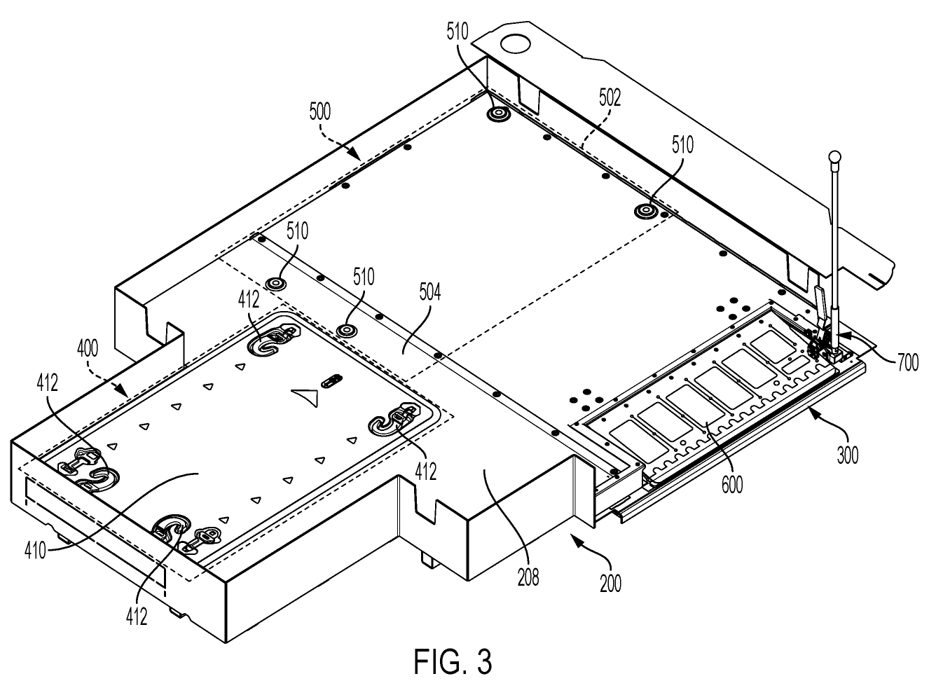

The ramp assembly 300 may be disposed in the pocket 250 of the floor weldment 202, above bottom wall 222 and beneath the ramp cover 208. The ramp assembly 300 may include a ramp platform 302 configured to be deployable through a door opening adjacent opening edge 234 of the weldment 202. The ramp platform 302 is configured to move between a stowed position underneath the ramp cover 208 as shown in FIG. 3 and a deployed position as shown in FIG. 1. In the deployed position shown in FIG. 1, the ramp platform 302 may be configured to provide rolling access for a wheelchaired passenger to enter or exit the vehicle 100 through opening 112. Specifically, an inboard edge 301 of the ramp platform 302 is aligned and elevated at a level adjacent to the ramp cover 208, while an outboard edge 303 of the ramp platform 302 is aligned adjacent the ground level where it may contact the ground surface 120. As shown, the ramp assembly 300 may include a transition flap assembly 600 pivotally coupled to or adjacent the ramp cover 208 to smoothly bridge any gaps in elevation between inboard edge 301 of the ramp platform 302 and the ramp cover 208.

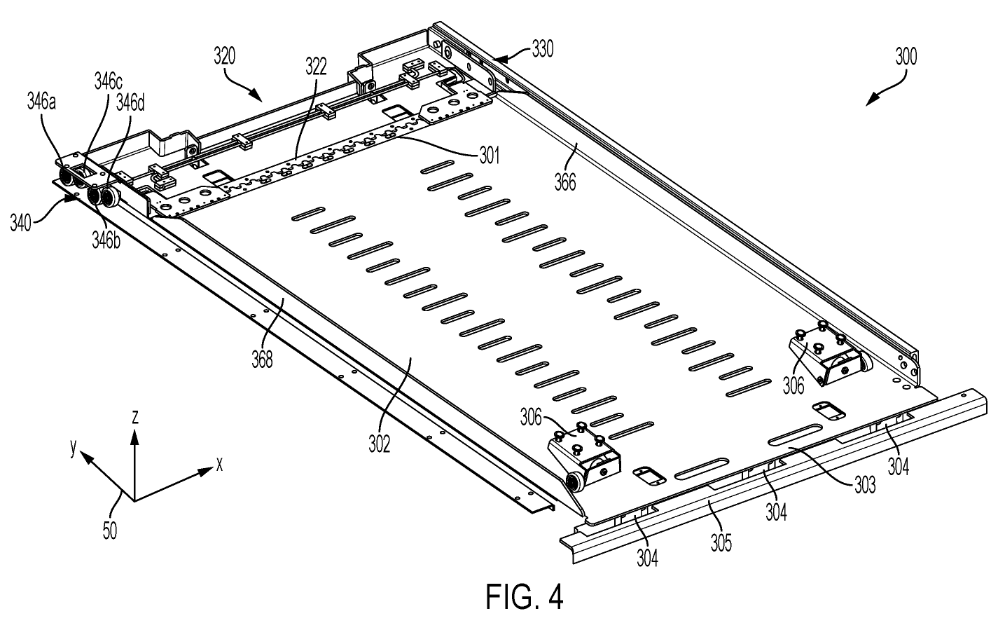

To facilitate a clear understanding of the spatial relationships and movement directions of the ramp assembly 300 described in FIGS. 4-7, a three-dimensional coordinate system 50 is employed. In this system, the X-axis is oriented along the longitudinal axis of the vehicle, with the positive (+) X direction aligned with the vehicle's intended path of forward travel, and the negative (-) X direction pointing rearward. The Y-axis extends laterally across the vehicle, with the positive (+) Y direction pointing to the vehicle's left side, as viewed from the perspective of the driver, and the negative (-) Y direction directed towards the vehicle's right side. The Z-axis represents the vertical dimension, with the positive (+) Z direction extending upwards away from the ground and the negative (-) Z direction downwards toward the ground. This coordinate system provides a standardized reference for describing the positions and movements of components within the ramp assembly, ensuring consistent and precise communication of the inventive concepts.

In the context of the defined coordinate system 50, any given component within the ramp assembly may possess six degrees of freedom, which encompass translational and rotational movements/positioning along and around the three principal axes: X, Y, and Z. Translational movement allows a component to shift linearly along the X-axis (forward and backward), the Y-axis (left and right), and the Z-axis (upward and downward). Rotational movement, on the other hand, permits a component to pivot around these axes, resulting in pitch (rotation around the Y-axis), yaw (rotation around the Z-axis), and roll (rotation around the X-axis). In the context of this invention, and as described more fully below, guide mechanisms are designed to restrict certain degrees of freedom to ensure alignment and smooth movement of the ramp platform 302 between the stowed and deployed positions notwithstanding the stack up of tolerances.

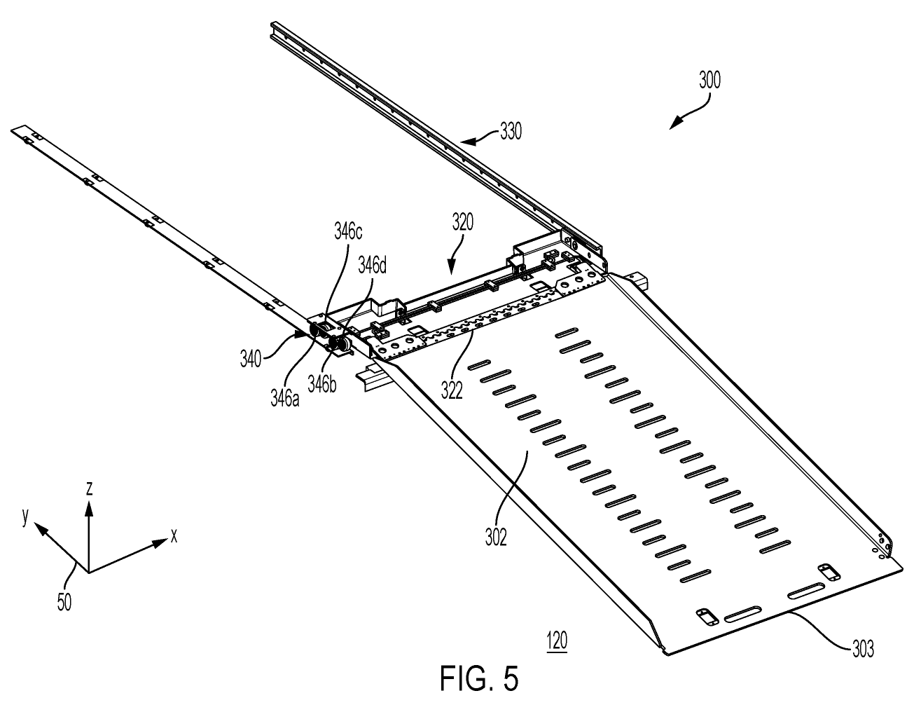

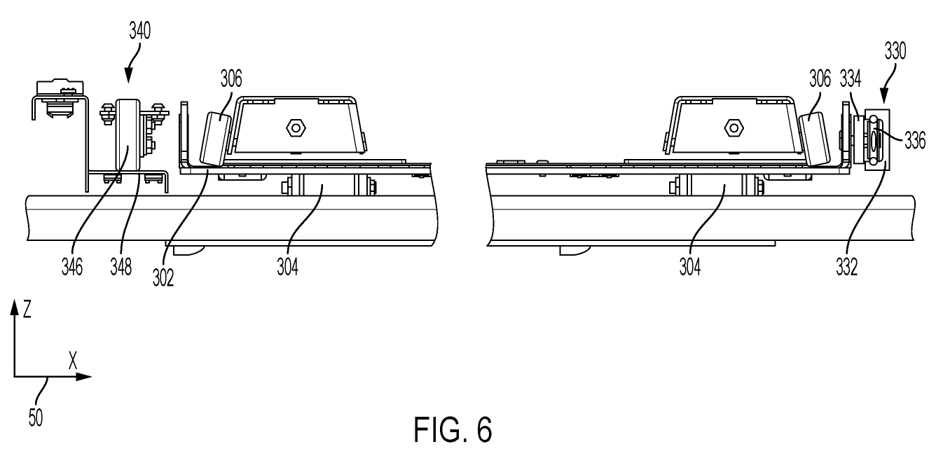

FIGS. 4 through 5 illustrate perspective views and FIG. 6 a front view of the ramp assembly 300, showcasing a carriage assembly 320, guide mechanisms 330, 340, and rollers 304, 306 collectively configured to guide the ramp platform 302 between the stowed position shown in FIG. 4 and the deployed position shown in FIG. 5 and to support and hold the ramp platform 302 when it is positioned largely outside the vehicle 100 in the deployed position. The carriage assembly 320 is coupled to the inboard end 301 of the ramp platform 302 via a hinge 322 that allows the ramp platform 302 to pivot from a generally horizontal position in the stowed position (i.e., generally parallel to the ramp cover 208) to a declined position in the deployed position (when viewed from the vehicle 100 to the ground 120). Through the hinge 322, the carriage assembly 320 also supports the inboard end 301 of the ramp platform 302, ensuring it remains substantially aligned along the Y-axis as the ramp platform 302 transitions between the stowed and deployed positions (i.e., reducing lateral deviation of the ramp platform 302 along the X-axis or twisting about the Z-axis during operation). Keeping the ramp platform 302 substantially aligned along the Y-axis helps prevent it from binding, banging, or rubbing against other components.

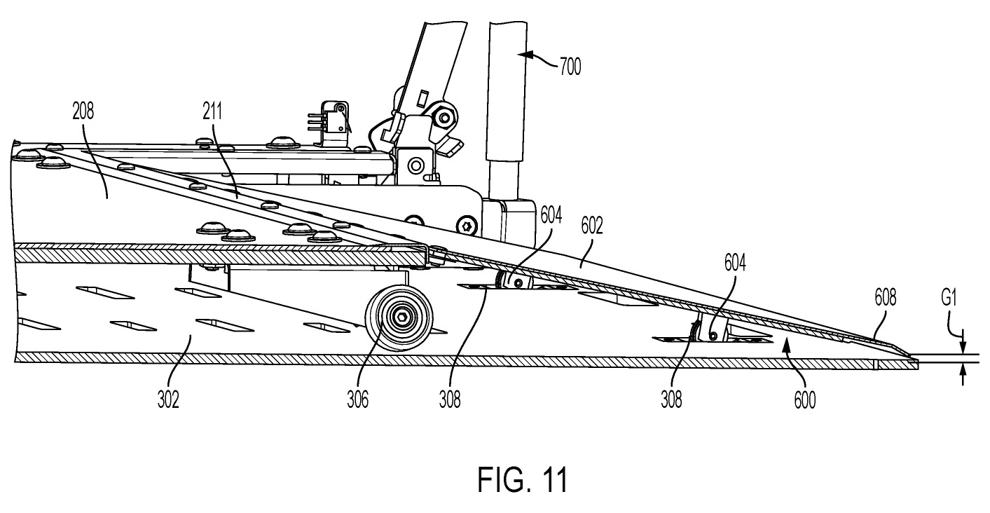

As the ramp platform 302 moves between the stowed and deployed positions, it may also be supported by and slide along one or more rollers 304 that support the platform 302 from the underside. The one or more rollers 304 may be coupled (individually or together as the shown roller assembly 305) to the floor weldment 202 from an underside through one or more apertures 307 disposed adjacent the door opening, as best shown in FIG. 2. The installation of the one or more rollers 304 from the underside of the weldment 202 assists in facilitating a thinner profile for the ramp assembly 300. While the ramp platform 302 is transitioning from the stowed position to the deployed position, there is a period when the ramp platform 302 is cantilevered in a horizontal position outside the floor frame 202 such that the outboard edge 303 of the ramp platform 302 is unsupported. To counteract this cantilevered force (i.e., the effects of gravity pulling the ramp platform 302 downward), one or more rollers 306 may be coupled to an underside of the ramp cover 208 (as best shown in FIG. 11) and configured to exert a downward force on the ramp platform 302 until it is at a desirable deployment position (i.e., at the edge of the lowered floor 308 at the door opening, underneath the transition flap assembly 600) in which it is ready to rotate downwards to contact the ground 120.

To ensure the ramp platform 302 remains aligned with the Y-axis during its movement between stowed and deployed positions and does not bind, it is essential that the carriage assembly 320 itself is sufficiently guided along the Y-axis. This guidance is necessary to prevent any lateral shifts that could disrupt the stable operation of the ramp assembly 300. To achieve this, the carriage assembly 320 may be equipped with at least two guiding mechanisms that direct its motion and positioning accurately along the desired path.

In one embodiment shown in FIGS. 4 through 6, the carriage assembly 320, may be guided by a first guide assembly and a second guide assembly, each playing a role in maintaining the proper alignment and seamless operation of the ramp platform. For instance, the two guide assemblies, designed to direct the movement of the carriage assembly 320, may differ in the degrees of freedom they permit, specifically to accommodate the stack up of tolerances commonly encountered in a field assembly method. In some embodiments, one of the guide assemblies may be configured to provide at least one degree of freedom more than the other guide assembly. For example, one of the guide assemblies may be configured to substantially limit all degrees of freedom for the carriage assembly 320 except for one, e.g., translational movement along the Y-axis, while the other guide assembly permits that same degree of freedom plus at least one more. In some embodiments, one of the guide assemblies may be configured to permit a greater degree of freedom of translational movement along the X-axis than the other guide assembly. In some embodiments, one of the guide assemblies may be configured to permit a greater degree of freedom of rotational movement about the Y-axis than the other guide assembly. In some embodiments, one of the guide assemblies may be configured to permit a greater degree of freedom of translational positioning along the Z-axis than the other guide assembly.

To make the ramp assembly 300 as thin as possible, the first and second guide assemblies may be substantially disposed to the side (in the +X and -X directions) of the ramp platform 302 and carriage assembly 320. In some embodiments, at least one of the first and second guide assemblies may be positioned to the outside of the ramp platform edge guards (e.g., first guide assembly 330 positioned in the +X direction relative to edge guard 366 and second guide assembly 340 positioned in the -X direction relative to edge guard 368) of the ramp platform 302. Additionally, in some embodiments, at least one of the first and second guide assemblies may be fully contained within the envelope of the height of the respective edge guard 366, 368.

The first guide assembly may comprise a guide rail configured to receive and guide at least one roller. In some embodiments, the guide rail may be coupled to the carriage assembly 320 or a housing for the ramp assembly 300 (in the case of a field assembly method, the housing may be the vehicle 100 or some portion of the vehicle), while the at least one roller may be coupled to the other of the carriage assembly 320 or the housing. With specific reference to the exemplary embodiment depicted in FIGS. 4-6, a first guide assembly 330 comprises a guide rail 332 that is coupled to the weldment 202 of the vehicle 100 (e.g., to the first riser 252) and at least one roller 336 that is coupled to the carriage assembly 320. As shown, the roller(s) 336 may be carried by a guide block 334 for easier assembly and mounting to the carriage assembly 320. The first guide rail 332 may be a substantially C-shaped cross-section with a channel configured to receive and allow the roller(s) 336 (and thus the carriage assembly 320) to travel along the length the first guide rail 332 (i.e., translational movement along the Y-axis). In some embodiments, the channel of the first guide rail 332 may engage with the roller(s) 336 to substantially limit translational positioning of the carriage assembly 320 along the X-axis, to limit rotational positioning of the carriage assembly about the X-axis, and/or to substantially limit translational positioning of the carriage assembly 320 along the Z-axis. In some embodiments, and as shown, multiple rollers 336 may be utilized with the guide rail 332. The incorporation of multiple rollers 336 may substantially limit rotational positioning of the carriage assembly about the X-axis and the Z-axis. It should be appreciated that the first guide assembly 330 may substantially restrain or limit motion/positioning in up to five degrees of freedom, allowing translational motion/positioning along as little as a single linear axis along the first guide rail 332. The linear axis along the first guide rail 332 may move corresponds to the Y-axis of the coordinate system in FIGS. 4 through 7. In one embodiment, the first guide assembly may be a precision linear rail such as the Redi-Rail Linear Guide provided by PBC Linear, which is configured to substantially limit motion/positioning in five degrees of freedom, allowing translational motion/positioning along a single linear axis along the length of the linear rail. Other cross-section configurations of the first guide rail 332 are contemplated such as an I-shaped cross section such that the one or more rollers 336 may contact opposite sides of the web and be retained between the flanges of the I-shaped first guide rail 332. In alternative embodiments, the first guide rail 332 may include rollers, bearing balls, or low friction material configured to retain the guide block 334.

The second guide assembly may also comprise a guide rail configured to receive and guide at least one roller. Consistent with one inventive feature disclosed herein, the second guide assembly may includes at least one more or one less degree of freedom than the first guide assembly. In some embodiments, the guide rail may be coupled to the carriage assembly 320 or a housing for the ramp assembly 300 (in the case of a field assembly method, the housing may be the vehicle 100 or some portion of the vehicle), while the at least one roller may be coupled to the other of the carriage assembly 320 or the housing. With specific reference to the exemplary embodiment depicted in FIGS. 4-6, the second guide assembly 340 is configured to provide at least one more degree of freedom than the first guide assembly 340. More specifically, the second guide assembly 340 includes a rail 348 that is coupled to the weldment 202 of the vehicle (e.g., the second riser 254) and at least one roller 346 that is coupled to the carriage assembly 320. The rail 348 is aligned similar to the rail 332, i.e., along the Y-axis to permit translational motion of the carriage assembly 320 along the Y-axis. The rail 348 supports the roller(s) 346 from the underside to substantially limit translational positioning of the support frame 320 in the negative (-) direction along the Z-axis. In some embodiments, one or more of the roller(s) 346 may additionally be configured for engagement with an underside of the ramp cover 208 or other guide structure to substantially limit translational positioning of the support frame 320 in the positive (+) direction along the Z-axis. For example, in the depicted embodiment of FIGS. 4-6, there are two rollers 346a, 346b configured to engage with the rail 348 and two rollers 346c, 346d configured to engage with the underside of the ramp cover 208. Depending upon the clearance between rollers 346c, 346d and the underside of the ramp cover 208, the roller(s) 346 may or may not substantially limit translational positioning of the carriage assembly 320 in the positive (+) direction along the Z-axis. Notably, the rail 348 (and, where relevant, the underside of the ramp cover 208) may have a width that exceeds that of the roller(s) 346 to allow flexible positioning of the carriage assembly 320 along the x-Axis. Depending upon the clearance between rollers 346c, 346d and the underside of the ramp cover 208, the second guide assembly 340 may or may not substantially limit rotational positioning of the carriage assembly 320 about the X-axis. As configured, the second guide assembly 320 does not substantially limit rotational positioning of the carriage assembly 320 about the Z-axis or Y-axis, although it is contemplated that features could be provided to limit such positioning if desired.

As previously discussed, assembly of the ramp assembly 300 within the modified floor assembly 200 requires accuracy such that the first and second guide assemblies 330, 340 work together and are not misaligned as to create a resistance to the motion of the ramp assembly 300. If both of the first and second guide assemblies 330, 340 were configured to substantially limit all degrees of freedom except for translational motion along the Y-axis, the tolerances in spacing between the rollers 336 and rollers 346 and in spacing between the rail 332 and rail 348 could be so tight so as to be unachievable in a field assembly application. However, by integrating a first guide assembly 330 that substantially limits the translational positioning of the carriage assembly 320 along the X-axis with a second guide assembly 340 that allows more freedom of movement/positioning in the X-axis, the ramp system offers increased flexibility for installers. This configuration accommodates variations that may arise during field assembly and, more importantly, does not require a ramp installer to space the two guide assemblies apart within potentially unachievably tight tolerances. The design also allows for a larger stack-up of tolerances, particularly in the spacing between the rollers 336 and 346. This flexibility is crucial in field assembly scenarios where precise alignment may be challenging to achieve, ensuring that the ramp system operates smoothly despite potential discrepancies in component placement.

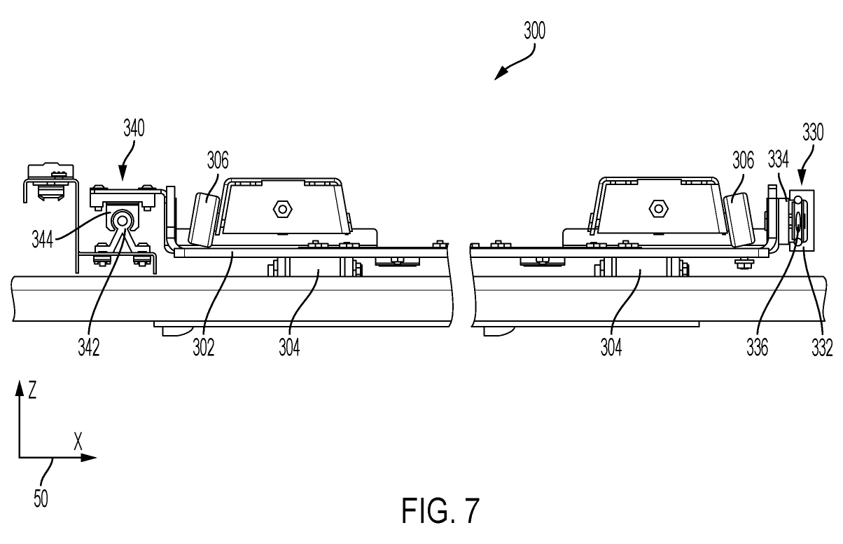

FIG. 7 illustrates an alternative configuration for second guide assembly 340,which may comprise a second guide rail 342 and a guide block (or follower) 344 configured to promote motion along the same linear guide axis as the first guide assembly 330 (i.e., for translational motion along the Y-axis). While the guide block 344 is coupled to the carriage assembly 322 and the guide rail 342 is coupled to the weldment 202, it is contemplated that their positioned may be reversed. Like the second guide assembly 340 illustrated in FIGS. 4 through 6, the second guide assembly 340 of FIG. 7 may promote at least one more degree of freedom than the first guide assembly 330. The guide block 344 of the second guide assembly 340 may have enough allow at least some motion or at least some flexibility in positioning of the carriage assembly 320 in one or both of the X-axis and the Z-axis. In the case of a cylindrical rail, as shown, the second guide assembly 340 may additionally provide the carriage assembly 320 with at least some degree of rotational freedom about the y-axis. The promoted flexibility along the X-axis and/or Z-axis need only be greater than the first guide assembly 330 by a substantial enough amount to accommodate the resulting stack-up of tolerances. For example, the freedom of translational motion required along the Z-axis may be as little as 3 millimeters in each of the +X and the -X directions. This may be sufficient to accommodate misalignment of the first guide rail 332 with the second guide rail 342 and/or any other manufacturing tolerance issues (such as the distance between roller(s) 336 and block 344. In some embodiments, the second guide assembly 340 may take form as the DryLin R shaft and guide block provided by igus motion plastics.

Referring to FIGS. 1, 3, 4 and 5, the operation of the ramp platform 302 involves manually transitioning it between a deployed position, as depicted in FIGS. 1 and 4, and a stowed position, as shown in FIGS. 3 and 4. In the deployed position, the ramp platform 302 is angled downward from the carriage assembly 320 to the ground surface 120, facilitating vehicle access for wheelchair users. To move the ramp platform 302 from the deployed position to the stowed position, a person must lift the outboard edge 303 of the ramp platform 302 upward along the Z-axis, overcoming the gravitational force acting on the platform 302 due to its weight. This lifting action can be physically demanding, particularly for individuals with limited strength or mobility. Once the ramp platform is raised in a horizontal axis (generally aligned in the XY plane), the user must simultaneously apply force along the Y-axis to slide the ramp platform 302 inward to the stowed position within the vehicle 100 as depicted in FIGS. 3 and 4. Conversely, to deploy the ramp platform 302, the process is reversed: the user pulls the ramp platform 302 outward along the Y-axis and lowers it to the ground, allowing it to descend along the Z-axis into the angled position of FIGS. 1 and 5. Resisting the weight of the ramp platform along the Z-axis to prevent an uncontrolled drop of the ramp platform 302 can present significant challenges for users with limited physical capability.

To address the challenges associated with manually operating the ramp platform 302, particularly the effort required to lift and control its weight, the ramp assembly 300 may incorporate a torsion spring assembly in some embodiments, as illustrated in FIGS. 4-5 and 8-10. This innovative assembly is designed to assist users by counterbalancing the ramp’s weight, thereby reducing the physical effort needed to transition the ramp between its deployed and stowed positions. The torsion spring assembly includes at least one torsion spring strategically coupled between the carriage assembly 320 and the ramp platform 302. In some embodiments, the torsion spring may take form as a coiled spring or an torsion bar, i.e., an uncoiled metal rod that may be elongated and substantially straight. The torsion spring is designed to act about the pivot point of the hinge 322 between the carriage assembly 320 and the ramp platform 302, providing a mechanical advantage through its twisting action. As the ramp platform transitions from a horizontal stowed position to an angled deployed position, the torsion spring experiences a twisting force, or torque, around its axis. The twisting action serves as a loading process and stores potential energy within the spring, which is then utilized to aid in lifting the ramp platform 302 during stowage. The unique design of the torsion spring assembly allows for the inclusion of a preload during the ramp assembly process, meaning that the spring is partially twisted even when the ramp platform 302 is in a horizontal position. This preloading feature ensures that some of the ramp platform’s 302 weight is counterbalanced from the outset, supporting at least some of the weight of the platform 302 throughout the entire process of stowing and deploying the ramp platform 302. By effectively offsetting the gravitational force acting on the ramp platform 302, the torsion spring facilitates smoother and more manageable operation, enhancing the overall usability of the ramp assembly 300 for individuals with limited strength.

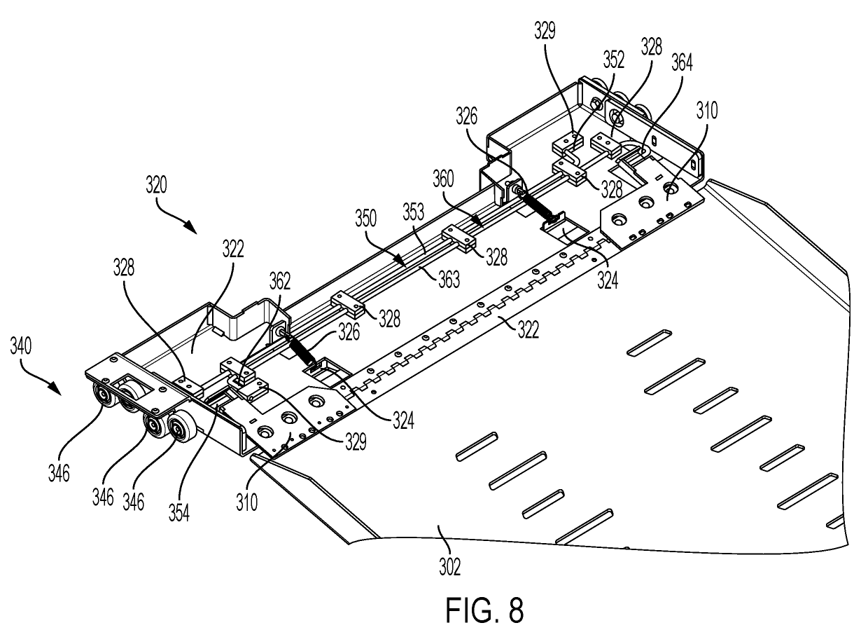

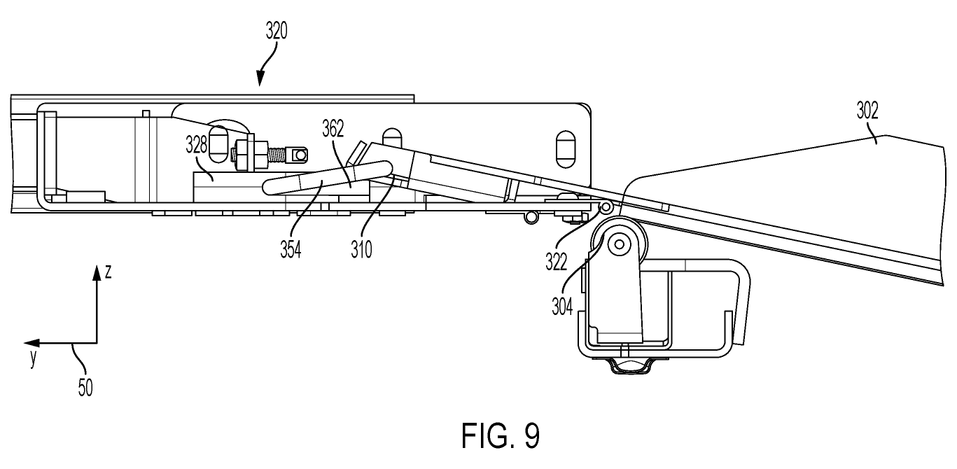

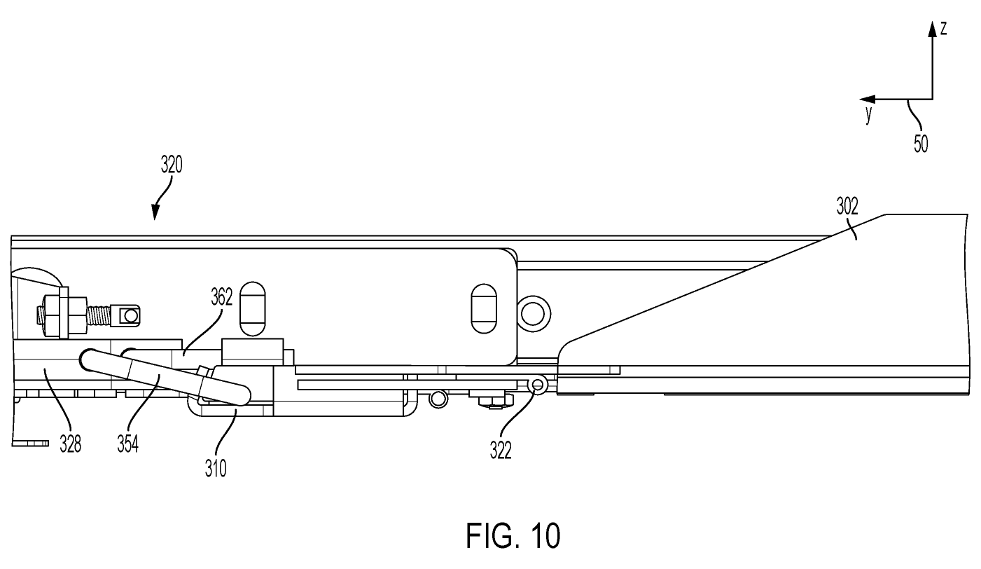

FIG. 8 illustrates a close up perspective view of one embodiment of a torsion spring assembly when the ramp assembly 300 is in the deployed configuration. FIGS. 9 and 10 illustrate side view of that torsion spring assembly with the ramp assembly in the deployed configuration (FIG. 9) and a horizontal configuration (FIG. 10). The transition flap assembly 600 is removed for visibility of the carriage assembly 320. As depicted, the torsion spring assembly may comprise a first torsion spring 350 and a second torsion spring, each being coupled between the carriage assembly 320 and the ramp platform 302. Although it is contemplated that the springs 350, 360 may take form as coiled springs, the springs 350, 360 take form as torsion bars in the depicted embodiment. As shown, each of the springs 350, 360 may comprise a straight bar section 353, 363 coupled to the carriage assembly 320 using one or more mounting blocks 328. The mounting blocks 328 hold the straight bar sections 353, 363 in a “loose” manner that allows the straight bar section 353, 363 to store and release potential energy through twisting. While the straight bar sections 353, 363 are shown coupled to the carriage assembly 320, it is contemplated that they may be coupled to the ramp platform 320 in some embodiments.

At one end, each torsion spring bar is fixed to the ramp platform 302, while the opposite end is attached to the carriage assembly 320. As the ramp platform 302 rotates relative to the carriage assembly 320 around the hinge 322, the ends of the torsion springs are acted upon to twist or untwist the straight bar sections 353, 363. When the ramp platform 302 moves downward to the deployed position, the ends of the springs 350, 360 twist the straight sections 353, 363, storing potential energy. Conversely, as the ramp platform 302 moves upward to a horizontal position, the ends of the springs 350, 360 untwist, releasing stored energy and assisting the user by counterbalancing the ramp platform’s 302 weight. This dynamic action of twisting and untwisting allows the torsion springs 350, 360 to effectively aid in the manual operation of the ramp assembly 300, ensuring smoother and easier transitions between positions.

In the torsion spring assembly depicted in FIG. 8, the first ends 352, 362 of the torsion springs 350, 360, which may be considered fixed ends, are securely coupled to the carriage assembly 320 using blocks 329. These first ends 352, 362 extend transversely from the straight bar sections 353, 363, anchoring them to the carriage assembly 320. The opposite second ends 354, 364 of the torsion springs are designed with a first segment extending transversely from the straight bar sections and may include a second segment that align generally parallel to the straight bar sections 353, 363. One or both of the first and second segments may be engagingly received by levers 310 that are fixedly attached to the ramp platform 302. These levers 310 extend towards and overlap the carriage assembly 320, strategically positioned on the opposite side of the hinge 322. When the ramp platform 302 pivots downward about the hinge 322 (in the negative direction along the Z-axis) into the deployed position, the levers 310 pivot upward about the hinge 322 (in the positive direction along the Z-axis). This upward movement of the levers 310 pushes the second ends 354, 364 upward, causing the straight bar sections 353, 363 to twist and store potential energy. Similarly, when the ramp platform pivots upward about the hinge 322 into a horizontal position (in the positive direction along the Z-axis), the levers 310 pivot downward about the hinge 322 (in the negative direction along the Z-axis) thereby releasing energy that is utilized to assist in lifting the ramp platform 302. This transverse segments at the ends of the straight bar sections 353, 363 aids in this process as it allows the torsion springs 350, 360 to effectively convert rotational motion between stored potential energy and kinetic energy by twisting and untwisting the straight bar sections 353, 363.

The two torsion springs 350, 360 are arranged on the carriage assembly 320 in a generally mirror-image format. This configuration means that one of the second ends 354, 364 engages with a first lever 310 on one side of the ramp platform 302, while the other engages with a second lever 310 on the opposite side. This mirror-image arrangement provides balanced support and ensures uniform distribution of the torsion spring force across the ramp platform 302. As a result, the system effectively counterbalances the weight of the ramp platform 302, reducing the effort required by users to stow or deploy the ramp platform 302. This design not only enhances the ease of operation but also contributes to the overall stability and reliability of the ramp system.

Referring now to FIGS. 1, 3, and 11-13, the ramp assembly 300 may further include a transition flap assembly 600 that includes a transition flap 602 that is hingedly coupled to a curbside edge 211 of the ramp cover 208 at a hinged connection 606. The curbside edge 211 of the ramp cover 208 is generally parallel to and spaced a distance inward from the opening edge 234 of the weldment. The transition flap 602 is configured to bridge substantially that entire distance between the curbside edge 211 of the ramp cover 208 and the opening edge 234 of the weldment 202 to provide a continuous floor surface interior to the vehicle. The transition flap 602 is moveable/rotatable about the hinged connection 606 between a lowered position and a raised position. As seen in FIGS. 11-13, when the ramp platform 302 is in either the deployed or stowed position, the transition flap 602 is disposed in the lowered position, and when the ramp platform 302 is between the deployed and stowed positions, the transition flap 606 is disposed in the raised position. In some embodiments, the transition flap assembly 600 may include a biasing member, such as a spring, that biases the transition flap 602 toward the lowered position, to prevent rattling of the transition flat 602 during vehicle transit, when the ramp platform 302 is stowed.

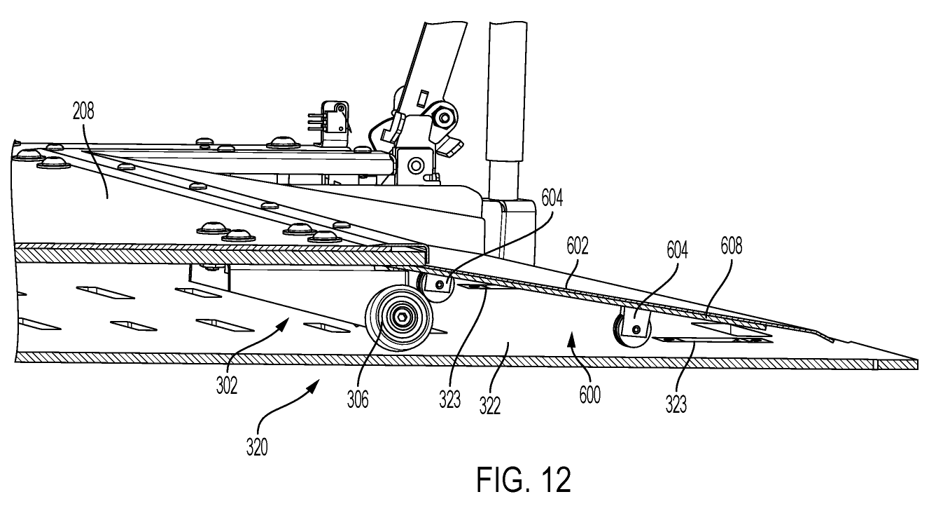

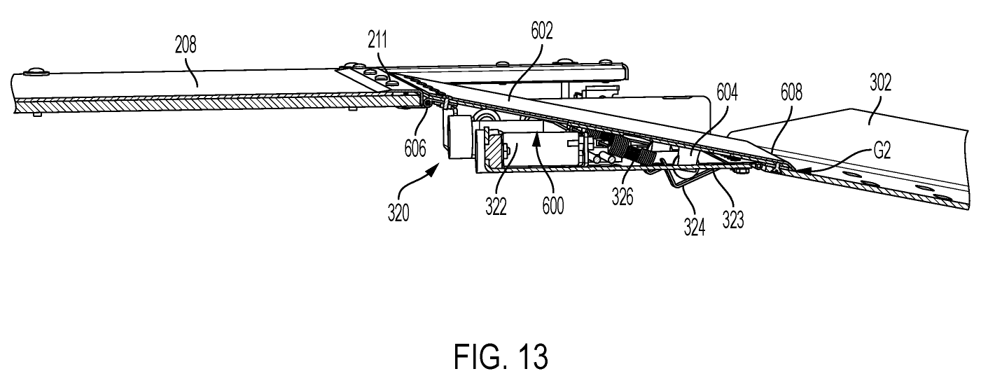

As seen more particularly in FIG. 11, in the lowered position and with the ramp platform 302 in the stowed position, the transition flap 602 is angled downward from the curbside edge 211 of the ramp cover where the outboard edge 608 of the transition flap 602 sits at a lower elevation than the ramp cover 208, thereby reducing the step-in height of the vehicle for ambulatory passengers entering or exiting the vehicle 100. As seen more particularly in FIG. 12, in the raised position, the transition flap 602 is spaced from the ramp platform 302 to eliminate or reduce interference and/or friction between the transition flap 602 and the ramp platform 302 as the ramp platform 302 moves between the deployed position and stowed position. As seen more particularly in FIG. 13, in the lowered position and with the ramp platform 302 deployed, the transition flap 602 may define an extension of the ramp platform 302 such that the transition flap 602 is substantially coplanar with the ramp platform 302 and helps reduce the ramp angle by providing a longer incline from the ground 120 to the false floor surface 209.

Any one or more of the transition flap 302, the ramp platform 302, and the carriage assembly 320 may include detent members or features that are designed to engage with corresponding detent members of features when the ramp platform 302 is in one or both of the stowed position and the deployed position to help hold the carriage assembly 320, ramp platform 302, and/or transition flap 602 in stationary positions. This configuration helps stabilize the transition flap 602 and/or ramp platform 302 as a passenger boards the vehicle.

In some embodiments, as seen in FIG. 11, the transition flap 602 may include a detent member in the form of one or more rollers 604 mounted to the underside of the transition flap 602 that are configured to engage with (in this case, received within) corresponding detent members in the form of one or more pockets 308 disposed on the ramp platform 302 surface adjacent its outboard edge 303, when the ramp platform 302 is in the stowed position. In some embodiments, the one or more pockets 308 may include a substantially U-shaped bracket wherein the one or more rollers 604 may rest in the U-shaped bracket, the face of the inner U-shaped bracket being vertically below the top face of the ramp platform 302. The nesting of the one or more rollers 604 in the one or more pockets 308 below the ramp platform 302 may provide adequate range of motion for the transition flap 602 to rotate downwards and reduce or eliminate a gap G1 between the transition flap 602 and the ramp platform 302 in the stowed position. It should be appreciated that not only does this provide a lower step-in height for ambulatory passengers entering and exiting the vehicle, but it also may reduce a tripping hazard.

In some embodiments, as seen in FIG. 13, the transition flap 602 may include a detent member in the form of one or more rollers 604 mounted to the underside of the transition flap 602 that are configured to engage with (in this case, received within) a corresponding detent member in the form of one or more pockets 323 disposed on the carriage assembly 320, when the ramp platform 302 is in the deployed position. The nesting of the one or more rollers 604 in the one or more pockets 323 below the ramp platform 302 may provide adequate range of motion for the transition flap 602 to rotate downwards and reduce or eliminate a gap G2 between the transition flap 602 and the ramp platform 302 whereby the transition flap 602 may be substantially coplanar with the ramp platform 302 and there is no surface differential to create a bump or a gap which would make maneuvering a wheelchair on the ramp platform 302 difficult.

As seen in FIG. 12, providing the transition flap 602 with detent members in the form of rollers 604 may provide an added benefit in that the rollers 604 may be configured to rollingly engage with the top surface of the ramp platform 302 as the ramp platform 302 moves between the stowed position and the deployed position, to not only support the transition flap 602 in the raised position but also reduce friction between the transition flap 602 and the ramp platform 302.

As discussed above, operating the ramp platform 302 involves manually transitioning it between a deployed and stowed position, a process that can be physically demanding, particularly for users with limited strength, due to the need to lift and slide the heavy platform. The difficulty a user encounters when transitioning the ramp platform 302 from the deployed position to the stowed position may be further compounded by the weight of the transition flap 602 resting atop the ramp platform 302. This additional weight increases the effort required to lift the outboard edge 303 of the ramp platform along the Z-axis. Moreover, if the transition flap 602 is equipped with an optional biasing spring that urges it toward the lowered position, the user must also overcome this additional force. The engagement between the corresponding detent members, such as the rollers 604 on the transition flap 602 and the pockets 323 on the carriage assembly 320, adds another layer of resistance against sliding the ramp platform along the Y-axis. These detent mechanisms, while crucial for maintaining the stability of the ramp system during vehicle operation, create a further barrier that the user must overcome to smoothly transition the ramp platform between positions.

Some embodiments may incorporate features that offset at least some of the downward force exerted upon the ramp platform 302 when the ramp platform 302 is in the deployed position and reduces the force required to disengage the rollers 604 from the pockets 323, thereby ensuring that users can manage the transition of the ramp platform 302 from the deployed position to the stowed position with minimal physical exertion. For example, as seen in FIG. 13, the pocket 323 may comprise a biasing member or assembly that exerts an upward force on the roller 604 to offset at least some of the transition flap 602 weight and/or the transition flap spring force. In some embodiments, the biasing assembly may comprise a substantially L-shaped bracket 324 and biasing device 326. The L-shaped bracket 324 may be hingedly coupled to the carriage 322 such that the long end of the L-shaped bracket 324 provides an inclined surface for the one or more rollers 604 to gradually leave the pocket 323 when the operator of the vehicle 100 is transitioning the ramp assembly 300 from the deployed position to the stowed position. Further, the L-shaped bracket 324 may be supported at is short end in a vertical direction by the biasing device 326. The biasing device 326 may be an extension spring, a gas spring, a torsional spring, or any other known biasing mechanism in the art. The biasing device 326 may have a designed spring rate such that the cover flap 602 may still overcome the supporting force of the biasing device 326 to become coplanar with the ramp platform 302 in the deployed position, but may be optimized to provide as much vertical support as desired to assist transitioning the ramp assembly 300 from the deployed position to the stowed position.

Referring to FIGS. 1, 3 and 14-15, the ramp assembly 300 may comprise a handle assembly 700, including a handle 702 designed for ergonomic use and ease of operation. The handle 702 may take form as an elongate rod fixed adjacent and generally perpendicular to the outboard end 303 of the ramp platform 302. This configuration allows users to grip the handle comfortably without the need to bend over, facilitating a more accessible and user-friendly experience. The length of the handle provides leverage, enabling users to effectively control the movement of the ramp platform between its stowed and deployed positions. By grasping the handle 702, the user can effortlessly lift or lower the ramp platform along the Z-axis and slide it along the Y-axis, making the transition between the stowed and deployed positions smooth and manageable for individuals of varying strength and mobility levels. The handle 702 may including a gripping member 732 at the upper end, which may take various forms, such a spherical ball as depicted, to enhance the user’s grip and provide comfort while maneuvering the ramp platform 302.

The handle assembly 700 includes a latch assembly 716, which effectively secures the ramp platform 302 in the stowed position during vehicle transit. This assembly features a housing 718, constructed from one or more brackets 706, which may be securely fixed to the ramp platform 302 adjacent to its outboard end 303 and situated laterally outside its edge guard. The bracket 706 may be coupled to at least a side bracket and a top bracket, both hidden, to fully enclose the latch assembly 716. The lower end of the handle 702 is attached to the housing 718 via a pivot member 722, such as the depicted pin, allowing the handle to rotate about a pivot axis defined by the pivot member 722 within a limited range of angles. A biasing member 712 may be interconnected between the housing 718 and the handle 702 (at a point spaced above the lower end of the handle 702) to hold the handle 702 in an origin position, which may be generally perpendicular to the ramp platform 302. The biasing member 712, which may take form as the depicted coiled spring, provides resistance against pivoting of the handle 702 in a counterclockwise direction 704 about the pivot member 722.

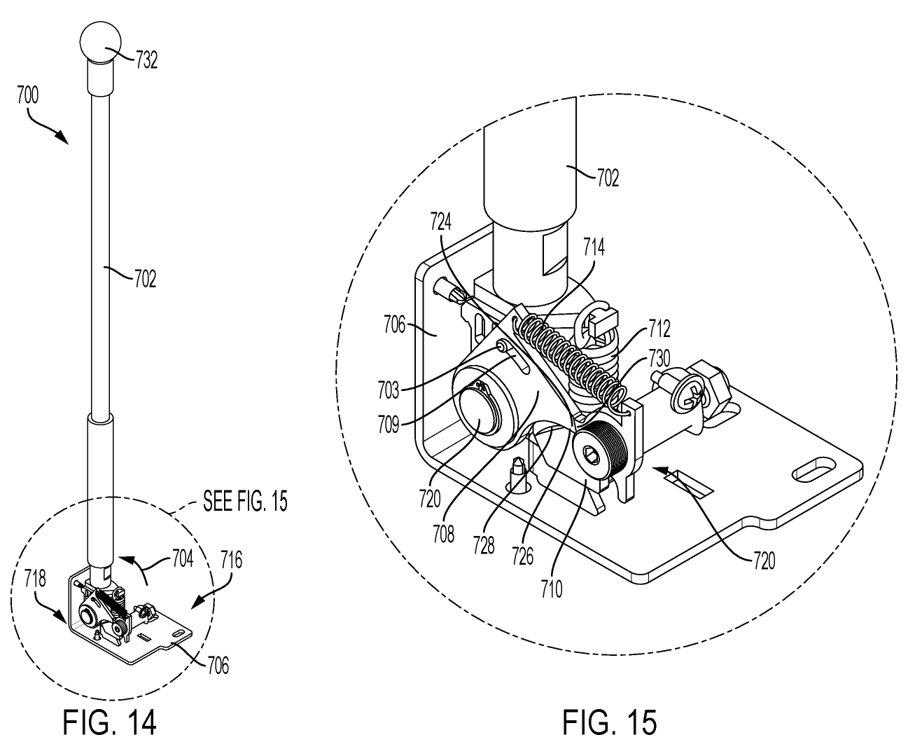

The housing 718 integrates a latch mechanism 720, comprising a first latch member 708 and a second latch member 710, designed to lock the ramp platform 302 in the stowed position and prevent unintended deployment or rattling during transit. The first latch member 708 is mounted to the housing 718 via the pivot member 722, enabling rotational movement about the pivot axis between a locked position, as shown in FIGS. 14 and 15, and an unlocked position. A biasing member 714, which may take form as the depicted coiled spring, connects the first latch member 708 to the housing 718, ensuring it naturally returns to the locked position. The second latch member 710 is fixed relative to the vehicle 100, such as on the weldment 202, positioned near the first riser 252 and the opening edge 234, ready to receive the first latch member 708 as the ramp platform is moved to the stowed position. In the locked position, shown in FIGS. 14-15, a tooth 724 on the first latch member 708 rests securely in a detent 726 of the second latch member 710. The second latch member 710 features a cam surface 728 (in this case, a ramp) adjacent to the detent 726, designed to engage with the tooth 724 and temporarily rotate the first latch member 708 in the counterclockwise direction 704 to the unlocked position, allowing the tooth to enter the detent as the ramp platform 302 is moved along the Y-axis to the stowed position. This configuration enables the latch mechanism 720 to automatically lock when the ramp platform 302 is pushed to the stowed position.

Additionally, the handle 702 includes a pin 703 that couples the handle 702 to the first latch member 708 via a slot 709 to provide unidirectional engagement between the handle 702 and the first latch member 708, as described hereinafter. When the handle 702 is positioned perpendicular to the ramp platform 302 in its origin position and the first latch member 708 is locked, the pin 703 is located at a first end of the slot 709, as seen in FIGS. 14-15. This pin and slot arrangement allows the user to unlock the latch mechanism by pulling the handle 702 in the negative (-) Y direction toward the ramp platform 302 deployed position, which naturally rotates the handle counterclockwise 704 around the pivot member 722. By virtue of engagement between pin 703 and the first end of the slot 709, this handle pulling motion pulls the first latch member 708 counterclockwise 704 to the unlocked position, disengaging it from the second latch member 710. In some embodiments, the interface 730 between the tooth 724 and the detent 726 defines a cam feature (e.g., a surface that is sloped relative to the vertical Z-axis, as depicted) that provides a slight push to the ramp platform 302 away from the stowed position as the tooth 724 rotates about the axis of the pivot member 722, thus preventing reengagement of the latch mechanism 720 until the platform 302 is deliberately pushed back. The pin and slot arrangement also permits automatic locking operation of the latch mechanism 320 even when a user is pushing the handle to its origin position (i.e., in the positive (+) Y direction in an effort to stow the ramp platform 302). More particular, the pin and slot arrangement allows the first latch member 708 to rotate counterclockwise independently of the handle 702 when the ramp platform 302 is moved from the deployed to the stowed position, with the slot 709 allowing this rotation until the pin 703 reaches the second end of the slot, facilitating automatic engagement with the second latch member 710 as described above.

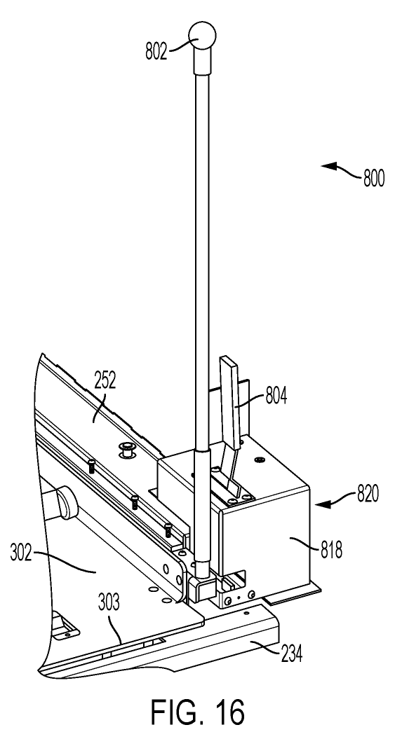

FIG. 16 illustrates an alternative embodiment of a handle assembly 800 for transitioning the ramp platform 302 between the stowed position and the deployed position and latching the ramp platform 302 in the stowed position. The handle assembly 800 may include a handle 802 fixedly coupled to the ramp platform 302 approximate the outboard edge 303. A laterally extended pin (not shown) may be coupled to or adjacent a lower end of the handle 802 for engagement with a latch mechanism (not shown) internal to housing 818. Housing 818 may be mounted to the weldment 202 adjacent the first riser 252 and the opening edge 234, as depicted. The latch mechanism may include a lever 804 configured to engage or disengage a latch member (not shown) with the pin (not shown), as customarily understood by a person of ordinary skill in the art. The lever 804 may be a handle lever actuated from one position to another, as depicted, but other embodiments such as a button or knob are contemplated herein.

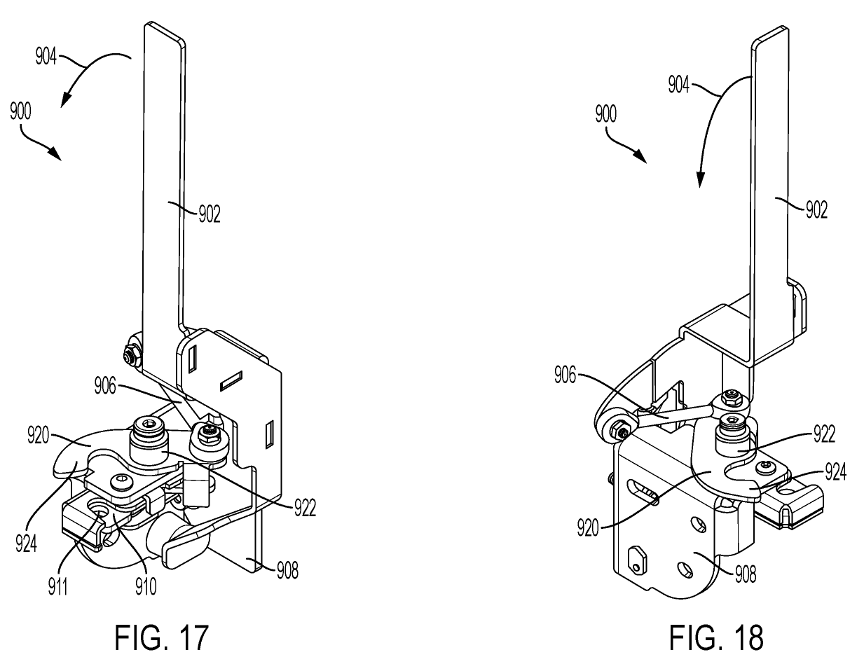

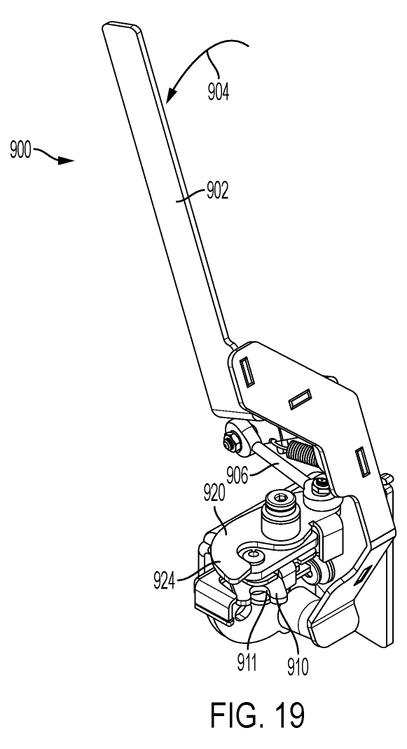

FIGS. 17-19 illustrate an alternative latching mechanism or assembly 900 that may be used in connection with the handle assembly 700 of FIG. 16. FIGS. 18 and 19 illustrate different perspective views of the same latching assembly 900 when in the latched position. FIG. 18 is a front perspective view of the latching assembly 900, while FIG. 19 is a rear perspective view of the latching assembly 900 to detail a kick-out bracket 920. The latching assembly 900 may include a lever 902 configured to actuate the latching assembly 900 from an engaged position in which it locks the ramp platform 302 in the stowed position and a disengaged position configured to release the ramp platform 302 to promote free motion. The lever 902 may be pivotably coupled to a support bracket 908. The support bracket 908 may be configured to attach to the floor weldment 202, for example to the first riser 252. The lever 902 may function substantially similar to lever 704 in FIG. 16. The lever 902 may be actuated by pivoting the lever about the support bracket 908 in a path that may correlate to arrow 904. The lever 902 may be coupled to a linkage 906. In the illustrative embodiment, the lever 902 is a bent sheet metal part weldment configured to couple to the linkage 906. In other contemplated embodiments, other well known constructions of linkages to transfer motion are contemplated. The linkage 906 may further be coupled to a kick-out bracket 920.The linkage 906 may be coupled to a first end of the kick-out bracket 920. A second end of the kick-out bracket 920 may include a kick-out protrusion 924. In between the first and second ends of the kick-out bracket 920, the kick-out bracket 920 may be rotatably coupled to the support bracket 908 at a pivot point 922.

The latching assembly 900 may comprise a latching bracket 910 which may be pivotably coupled to the support bracket 908. In the unlatched configuration, the latching bracket 910 may rotate to a position in which a latching cavity 911 may be accessible to capture a feature of the ramp platform 302. In the latched configuration, the latching bracket 910 may be rotated such that the open-ended cavity 911 is facing a part of the support bracket 908 to close off the latching cavity 911 such that the ramp platform 302 is fixed.

FIG. 19 illustrates a front perspective view of the latching assembly 900 in the unlatched configuration. The lever 902 is pivoted roughly along the arrow 904 and the linkage 906 transfers the motion to rotate the kick-out bracket 920 about the pivot point 922. Actuating the lever 902 additionally rotates the latching bracket 910 to expose cavity 911 to promote the ramp platform 302 to be released. When the kick-out bracket 920 is pivoted, the kick-out protrusion 924 is configured to contact the feature of the ramp platform 302 captured by the latching bracket 910. This contact with the kick-out protrusion 924 moves the ramp platform 302 by a small distance to prevent the latching bracket 920 from recapturing the ramp platform 302. The small distance may be configured based on the profile of the kick-out bracket 920 and length of the kick-out bracket protrusion 924. In the illustrative embodiment, the ramp platform 302 may be pushed out as little as 1/8 of an inch. In other embodiments, the kick-out bracket 920 may contact any part of the ramp platform 302, not exclusively the feature captured by latching bracket 910.

By preventing the recapture of the latching bracket 910, this allows an operator to use only a single hand when operating the ramp. If the ramp was not pushed out by the kick out bracket 920, the operator would need to actuate the lever 902 to release the ramp platform 302, and simultaneously with their other hand use the handle 802 to move the ramp platform 302 before releasing the lever 902. The kick-out bracket 920 allows the operator to actuate the ramp assembly in sequential steps by first actuating the lever 902 to release the ramp platform 302 and then transferring their hand to the handle 802 to move the ramp platform 302.

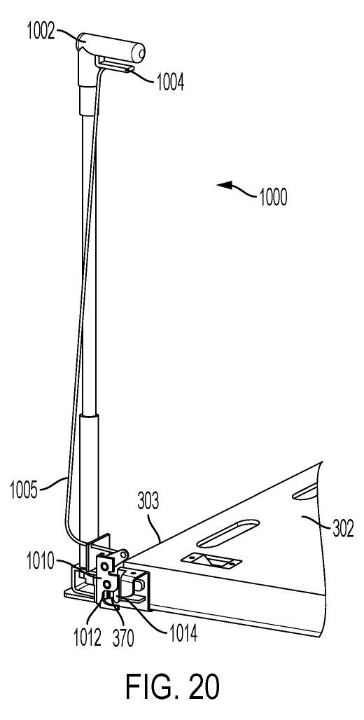

FIG. 20 depicts yet another alternative embodiment of a handle assembly 1000. In this embodiment, a release 1004, which may take form as the depicted lever or a button, may be coupled to the gripping end of handle 1002 such that the operator may solely use one hand when operating the ramp assembly 300. The release 1004 may be operatively connected to the latching device 810, as conventionally understood by a person of ordinary skill in the art, via a cable 1005. In one embodiment, the latching device 810 comprises a slot 1012 configured to lockingly receive a pin 370 or other feature coupled to the ramp platform 302 adjacent the outboard edge 303. A latch 1014 may be positioned within the slot 1012 to lock the pin or other feature in the slot. The release 1004 may be coupled to the latch 1014 via cable 1005 so that the user can manipulate the latch 1014 between a locked and unlocked position.

As illustrated in FIG. 2, the weldment 202 of the vehicle's floor assembly 200 may be equipped with additional risers 262, which, in conjunction with risers 252, 254, and 256, may serve as foundational and structural mounting points for wheelchair securements. These risers are strategically positioned to provide robust support and integration for the securement systems. In certain embodiments, risers 262 are positioned at a lower elevation compared to risers 252, 254, 256 facilitating the incorporation of wheelchair securements within the floor assembly 200, at least partially beneath the false floor surface 209. The one or more risers 262 may be configured to raise the later-described securement systems to an appropriate level relative to the false floor surface 209. This design ensures that securements are seamlessly integrated, providing a flush and unobtrusive surface. The risers 262 may include fastening features for the securement system to secure to including threaded holes, weld nuts, PEM nuts, rivets, or any other known method. The risers may be segmented as shown for efficient use of metal material. Inserts or other filler material may be utilized to fill the gap between risers. The inserts may be made of a material such as a high density foam. The inserts may provide other functions such as sound deadening while the vehicle 100 is in operation.

The front wall 230 of the weldment 202 may be designed with pockets 258, 260, which define specific mounting points for additional wheelchair securements. These recessed pockets are strategically located in the front wall 230, forward of the ramp assembly 300, enabling the integration of securements within the floor assembly 200, specifically beneath the front seat of the vehicle 100 and below the OEM vehicle floor 101. This configuration not only optimizes the space within the vehicle but also enhances the safety and accessibility for wheelchair users by ensuring secure and stable seating arrangements.

FIGS. 3 is a perspective view of the lowered floor assembly 200 separate from the vehicle 100. The lowered floor assembly 200 may include a ramp assembly 300, as previously described. The modified floor assembly 200, may further include one or more securement areas 400, 500. As depicted in FIGS. 1 and 3, the modified floor assembly 200 includes a rear securement area 400 and a front securement area 500. The rear securement area 400 may be substantially further toward the back of the vehicle 100 than and rearward of the ramp assembly 300. The rear securement area 400 may be defined by an integrated (drop-in) securement system 410 coupled to one or more of the risers 262 of weldment 202. The securement system 410 may comprise Q’Straint’s Q’STRAINT ONE wheelchair platform system or any of the systems described in PCT Patent Publication No. WO2023/018802 and U.S. Patent Pub. No. 2024/0173180, the contents of which are incorporated herein by reference. The securement system 410 may include at least one securement tiedown 412. The second securement area 500 may substantially overlap or overlie the ramp assembly 300. The second securement area may include one or more securement anchor points 510, such as Q’Straint’s Slide ‘N Click Wheelchair Securement Rotating Anchorage, which are configured to receive a removable wheelchair securement device, such as Q’Straint’s QRT series of retractor tie-downs. In the illustrative embodiment, the second securement area 500 comprises four securement connections 510, two at the front 502 of securement area 500 (mounted through the ramp cover 208 and to the riser 252) to the and two at the rear 504 of securement area 500 (mounted through a floor structure 270 and to the riser 262). The front 502 of securement area 500 may be further towards the front of the vehicle 100 than the ramp assembly 300 and the rear 504 of securement area 500 may be further towards the rear of the vehicle 100 than the ramp assembly 300.

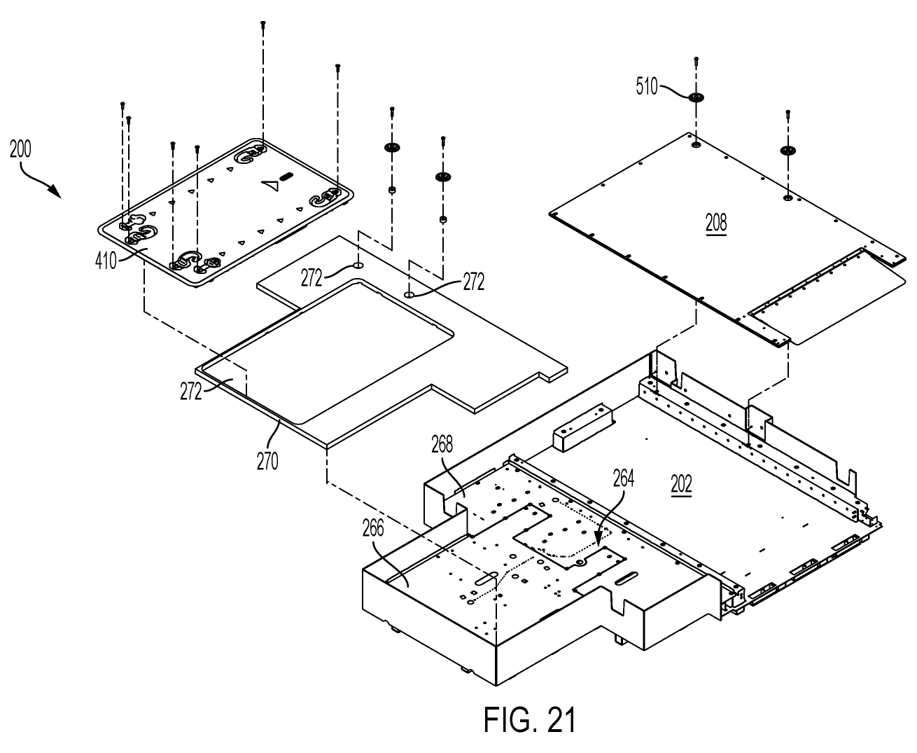

Referring to FIG. 21, which provides an exploded view of the floor assembly 200, the design may incorporate a modular subfloor 264, which consists of one or more sheets or panels 266, 268 that are mounted, in some embodiments directly, atop the risers 262. This modular subfloor serves as a foundational layer, providing structural support and stability to the floor assembly 200. Above the modular subfloor 266, 268 is a floor structure 270 that bridges the elevational gap between the top of the subfloor 264 and the false floor surface 209. Ideally, the floor structure may take form as a composite or engineered floor that offers a high strength, low weight solution. In some embodiments, the floor structure may be a honeycomb panel manufactured by Plascore®. The upper surface of the floor structure 270 is configured to be generally flush with the top surface of the ramp cover 208, ensuring a seamless and continuous floor surface throughout the vehicle's interior. Additionally, the Plascore floor structure 270 is designed with one or more apertures or openings 272 specifically for receiving the securement system 410 and securement anchor points 510. These apertures facilitate the integration of the securement systems, ensuring that wheelchair securements are securely and effectively incorporated into the floor assembly. This configuration not only enhances the functionality and safety of the vehicle but also maintains a clean and unobtrusive floor design.

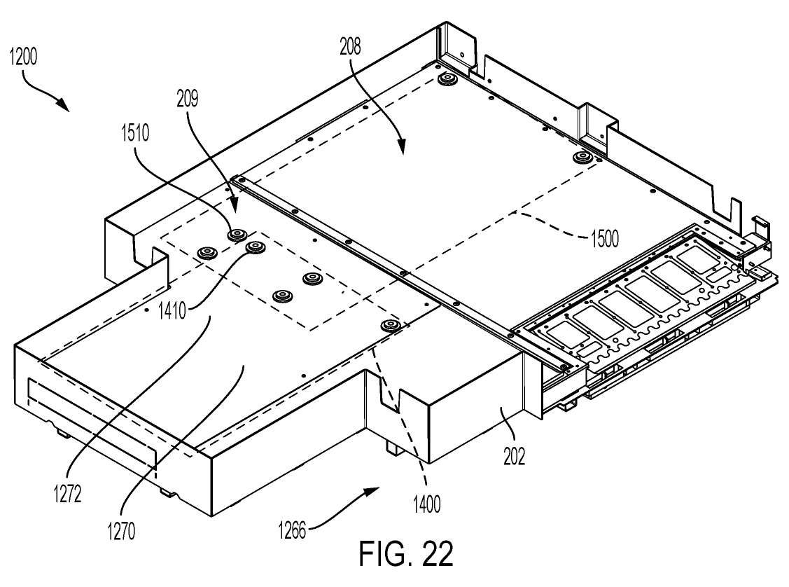

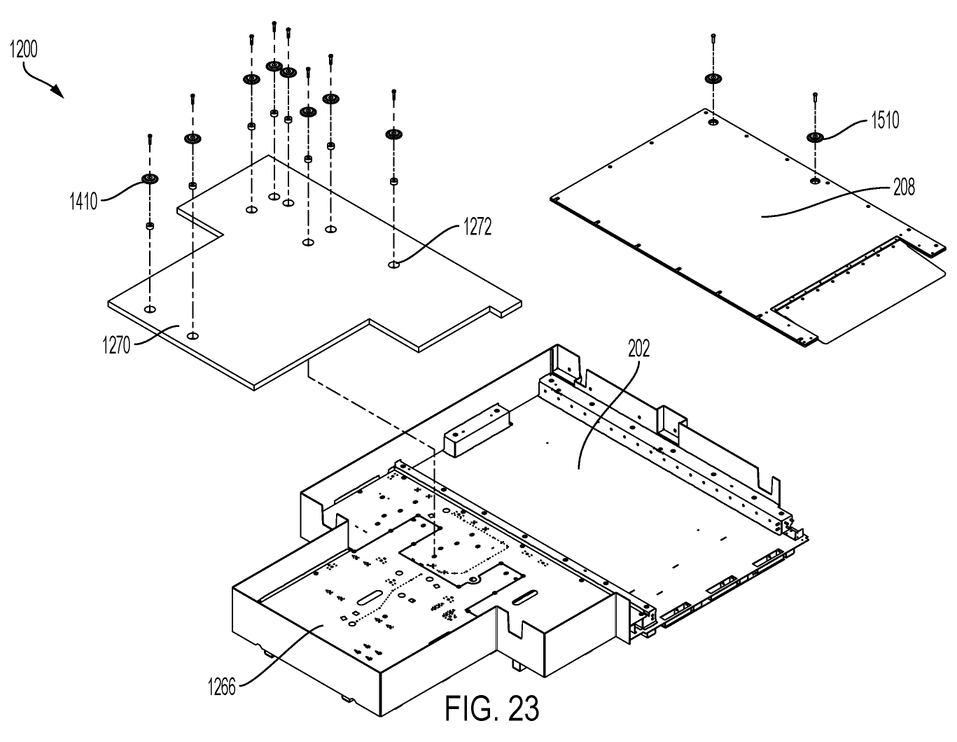

Referring now to FIGS. 22 and 23, a first variant of a lowered floor assembly 1200 is depicted. As with the previous embodiment, the lowered floor assembly comprises a layered false floor system comprising subfloor 1266 and floor structure 1270 with openings for receiving wheelchair securements, in this case four anchor points 1410 that define a rear securement area 1400 and four anchor points 1510 that define a front securement area 1500.

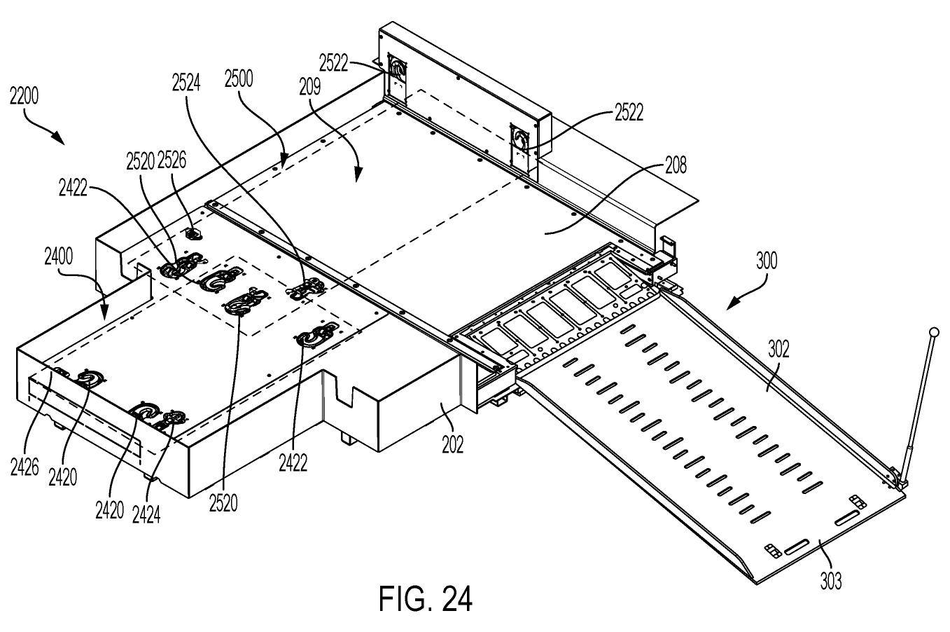

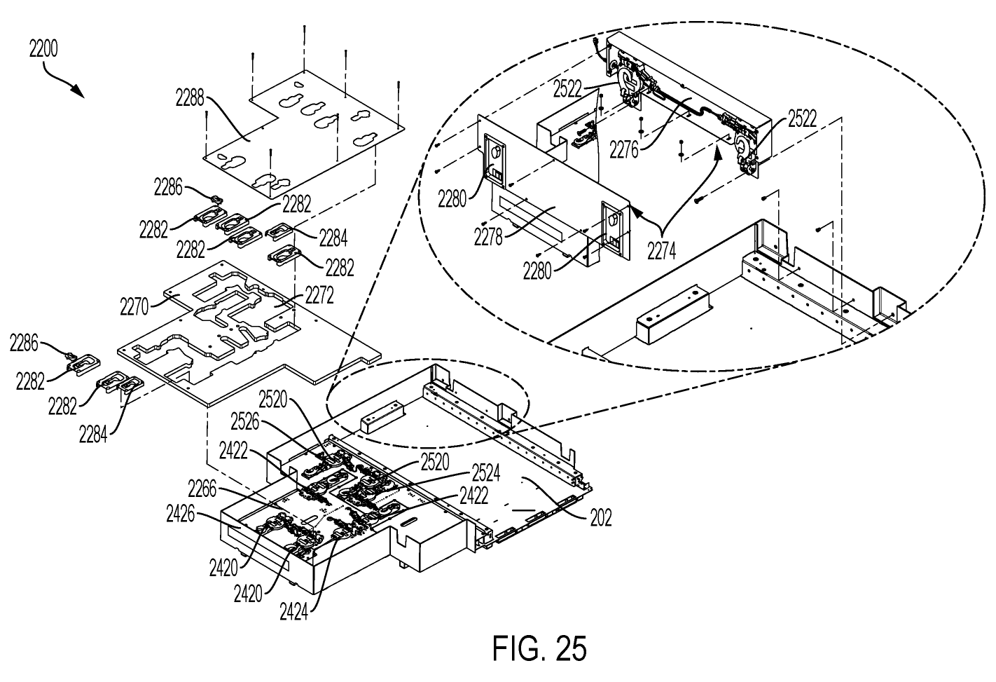

Referring now to FIGS. 24 and 25, a second variant of a lowered floor assembly 2200 is depicted. As with the previous embodiments, the lowered floor assembly comprises a layered false floor system comprising subfloor 2266 and floor structure 2270 with openings 2272 for receiving wheelchair securements. In this case, however, the first and second securement areas 2400, 2500 may comprise a plurality of individually mounted retractors each having a thickness that is roughly the same (plus or minus) as the floor structure 2270. The retractors may be substantially similar to the retractors described in PCT Patent Publication No. WO2023/018802 and U.S. Patent Pub. No. 2024/0173180. The first (rear) rear securement area 2400 may have at least one rear retractor 2420 and at least one front retractor 2422. Two rear retractors 2420 and two front retractors 2422 are shown in the illustrative embodiment. The rear retractors 2420 may be configured to attach to a rear of a wheelchair when positioned in the first securement area 2400 and the front retractors 2422 may be configured to attach to a front of a wheelchair when positioned in the first securement area 2400. The first securement area 2400 may additionally include a seat belt retractor 2424 on a first side of the securement area 400 and an occupant belt anchor point 2426 on an opposite side of the securement area.

The second (front) securement area 2500 may similarly include at least one rear retractor 2520 and at least one front retractor 2522. Two rear retractors 2520 and two front retractors 2522 are shown in the illustrative embodiment. In an effort to save space within the vehicle 100, the front retractors 2522 may be positioned on, adjacent, or forward of the front wall 230 of the floor weldment 202. It is contemplated that the front retractors 2522 may include a restraining device such as a latch or a magnet to keep the front retractor 2522 hook from falling onto the floor surface 209 when it is in the stowed position. In alternative embodiments, it is contemplated that the securement connections 510 of the FIG. 3 embodiment, or other types of securement may also be coupled to, adjacent, or forward of the front wall 230 of the floor weldment 202. The second securement area 2500 may additionally include a seat belt retractor 2524 and an occupant belt anchor point 2526.

For a finished appearance, the front retractors 2522 may be contained within a housing 2274 that nests within pockets 258 and 260 (see FIG. 2). The housing 2274 may comprises a base member 2276 and a cover member 2278 with apertures holding retractor covers 2280 that provide access to the front retractor 2522 tiedown belts and hooks and a nest for storing the hooks when not in use. Additionally, each of the remaining retractors 2420, 2422, 2520, 2424, 2524 and occupant belt anchor points 2426, 2526 may be provided with cover members 2282, 2284, 2286 that similarly provide access and storage nests. A finish panel 2288 may be mounted over and with those covers in apertures for a finished appearance.

Other wheelchair securement configurations are contemplated for the rear and front securement areas. For example, a vehicle may be equipped with only a front securement area that includes securement connections similar to anchor points 1510 and/or retractors 1520, 1522, seat belt retractor 1524 and/or occupant belt anchor point 1526. In another example, a vehicle may be equipped with only a rear securement are that includes securement connections similar to anchor points 1410 and/or retractors 1420, 1422, seat belt retractor 1424 and/or occupant belt anchor point 1426. In another example, the rear securement area may include securement connections similar to anchor points 1410, while the front securement area may include securement connections similar to retractors 1520, 1522, seat belt retractor 1524 and/or occupant belt anchor point 1526. In another example, the rear securement area may include securement connections similar to retractors 1420, 1422, seat belt retractor 1424 and/or occupant belt anchor point 1426, while the front securement area may include connections similar to anchor points 1510.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. An access device for a vehicle comprising:
a platform assembly configured to provide access to the vehicle for a physically limited passenger, the platform defining a Y-axis along which the platform is moveable between a stowed position and a deployed position, an X-axis that is transverse to the first axis and parallel to a platform surface of the platform in the stowed position, and a Z-axis that is transverse to the first axis and normal to the platform surface of the platform in the stowed position;
a first guide mechanism coupled to the platform assembly and configured to permit translation of the platform assembly along the Y-axis between the stowed position and the deployed position;
a second guide mechanism coupled to the platform assembly and configured to permit translation of the platform assembly along the Y-axis between the stowed position and the deployed position;
wherein the first guide mechanism substantially limits at least one more degree of freedom than the second guide mechanism.

2. The access device of claim 1, wherein the second guide mechanism permits greater freedom of translational positioning along the X-axis than the first guide mechanism.

3. The access device of claim 2, wherein the second guide mechanism permits at least approximately ±3 mm of translational positioning along the X-axis.

4. The access device of claim 1, wherein the second guide mechanism permits greater freedom of rotational positioning about the X-axis than the first guide mechanism.

5. The access device of claim 1, wherein the second guide mechanism permits greater freedom of translational positioning along the Z-axis than the first guide mechanism.

6. The access device of claim 1, wherein the second guide mechanism permits greater freedom of rotational positioning about the Z-axis than the first guide mechanism.

7. The access device of claim 1, wherein the second guide mechanism permits greater freedom of rotational positioning about the Y-axis than the first guide mechanism.

8. The access device of claim 1, wherein the first guide mechanism comprises a linear guide.

9. The access device of claim 8, wherein the linear guide comprises at least one roller coupled to the platform assembly and at least one guide rail configured to be coupled to the vehicle.

10. The access device of claim 1, wherein the second guide mechanism comprises at least one roller and at least one guide surface.

11. The access device of claim 10, wherein the at least one roller of the second guide mechanism is coupled to the platform assembly and the at least one guide surface is configured to be coupled to the vehicle.

12. The access device of claim 1, wherein the platform assembly comprises a first edge guard disposed on the platform surface opposite from a second edge guard.

13. The access device of claim 12, wherein the first guide mechanism and platform surface are disposed on opposite sides of the first edge guard.

14. The access device of claim 12, wherein the second guide mechanism and platform surface are disposed on opposite sides of the second edge guard.

15. The access device of claim 13, wherein a height of the first guide mechanism is less than a height of the first edge guard.

16. The access device of claim 13, wherein the first guide mechanism is substantially contained within a height of the first edge guard.

17. The access device of claim 13, wherein a height of the second guide mechanism is less than a height of the second edge guard.

18. The access device of claim 13, wherein the second guide mechanism is substantially contained within a height of the second edge guard.

19. A vehicle comprising the access device of claim 2.

20. A method of modifying a vehicle to include the access device of claim 2 to provide access to a physically limited passenger, the method comprising the steps of:
coupling the first guide mechanism to the vehicle;
coupling the second guide mechanism to the vehicle, wherein the second guide mechanism is spaced apart from the first guide mechanism; and
coupling the platform assembly between the first guide mechanism and the second guide mechanism.
